(19) United States
(12) Patent Application Publication
(10) Pub. No.: US 2008/0029174 A1
(43) Pub. Date: Feb. 7, 2008

(54) Fluid Control Device

(75) Inventor: Kenro Yoshino, Miyazaki (JP)

Correspondence Address: BUCHANAN, INGERSOLL & ROONEY PC, POST OFFICE BOX 1404, ALEXANDRIA, VA, 22313-1404, US

(73) Assignee: ASAHI ORGANIC CHEMICALS INDUSTRY CO., LTD., Nobeoka-shi (JP)

(21) Appl. No.: 11/661,388

(22) PCT Filed: Aug. 29, 2005
(86) PCT No.: PCT/JP05/16168

§ 371 Date: Feb. 28, 2007

(30) Foreign Application Priority Data
Aug. 31, 2004 (JP) 2004-252092
Aug. 31, 2004 (JP) 2004-252870

(51) Int. Cl. G05D 7/06

(52) U.S. Cl. 137/828

(57) ABSTRACT

A fluid control system with easy installation in a semiconductor production system etc. and pipe and wiring connections, with reduced pressure loss due to pipe connections, with easy change of arrangement of modules, free from corrosion even using a corrosive fluid for the fluid, and enabling control of the flow rate even with pulsation of the inflowing fluid is provided. The fluid control system of the present invention is characterized by having a flowmeter sensor part having an ultrasonic oscillator generating an ultrasonic wave in a fluid and an ultrasonic oscillator receiving the ultrasonic wave generated from the ultrasonic oscillator and outputting a signal to a flowmeter amplifier and a control valve controlling the state of flow of fluid to a predetermined state by a working pressure, wherein the flowmeter sensor part and the control valve are arranged inside a casing having a fluid inlet and a fluid outlet.

### TECHNICAL FIELD

The present invention relates to a fluid control system used in a fluid transport pipe where control of the fluid is required. More particularly, it mainly relates to a fluid control system with easy installation in a semiconductor production system etc. and pipe and wiring connections and with no concern over corrosion even if using a corrosive fluid for the fluid.

### BACKGROUND ART

In the past, as one step in the process of production of a semiconductor, use has been made of wet etching using a washing solution comprised of fluoric acid or another chemical diluted by pure water to etch the wafer surface. It is considered that the concentration of the washing solution in this wet etching has to be managed with a high precision. In recent years, the method of managing the concentration of the washing solution by the ratio of flow rates of the pure water and chemical has become the mainstream. For this reason, a fluid control system managing the flow rates of the pure water and chemical with a high precision has been used.

Various fluid control systems have been proposed, but there is a control system 101 for the flow rate of pure water as shown in FIG. 10 which controls the flow rate when making the temperature of the pure water variable (for example, see Patent Document 1). This was a control system 101 provided with a flow rate regulating valve 102 adjusted in opening degree by receiving the action of the working pressure so as to regulate the flow rate of the pure water, a working pressure regulating valve 103 for regulating the working pressure supplied to the flow rate regulating valve 102, a flow measuring device 104 for measuring the flow rate of the pure water output from the flow rate regulating valve 102, and a shutoff valve 105 for allowing or cutting off the flow of pure water running through the flow measuring device 104 and balanced the working pressure regulated by the working pressure regulating valve 103 and the output pressure of the pure water at the flow rate regulating valve 102 so as to control the flow rate of the pure water output from the flow rate regulating valve 102 to become constant, characterized by being provided with a control circuit for feedback control of the working pressure supplied from the working pressure regulating valve 103 to the flow rate regulating valve 102 based on the measurement value of the flow measuring device 104 so that the measurement value became constant. The effect was that even if the output pressure at the flow rate regulating valve 102 changed along with a change in temperature of the pure water, the working pressure was regulated in real time in accordance with that change and therefore the flow rate of the pure water output from the flow rate regulating valve 102 was regulated, so the flow rate of the pure water could be maintained at a constant value with a high precision.

Further, as a module for fluid control, there was the fluid control module 106 such as shown in FIG. 11 connected in-line to a fluid circuit transporting the fluid (for example, see Patent Document 2). This comprised a housing 107 having a chemically inert channel, an adjustable control valve 108 connected to the channel, a pressure sensor 109 connected to the channel, and a constricted portion 110 positioned in the channel, the control valve 108 and the pressure sensor 109 contained in a housing 107, and further a driver 111 having a mechanical, electrical, or pneumatic configuration for driving the control valve 108 and a controller 112 electrically connected to the control valve 108 and pressure sensor 109 contained in the housing 107. The effect was that it was possible to measure the flow rate in the channel from the pressure difference measured in the fluid circuit and the diameter of the constricted part 110 and possible to drive the control valve 108 by feedback control based on the measured flow rate so as to determine the flow rate in the channel with a high precision.

### DISCLOSURE OF THE INVENTION

However, the above conventional control system 101 of the flow rate of the pure water was branched into numerous parts, so when installed in a semiconductor production system etc., pipe connection work, electrical wiring, and air pipe work had to be performed for each component. There were therefore the problems that the work was complicated and required time and that the piping and wiring were troublesome and mistakes easily occurred. Further, when connecting pipes, tubes, engagement parts, etc. were used for the connections, so pressure loss ended up occurring at the connection parts. There was therefore the problem that this pressure loss affected the flowmeter side resulting in larger measurement error of the flow rate and making accurate control by the flow rate difficult. Further, the flow measuring device 104 used parts liable to corrode, so there was the problem that when using a corrosive fluid as the fluid, the permeation of corrosive gas led to corrosion of the parts in the flow measuring device 104.

Further, in the conventional flow rate control module 106, when using a corrosive fluid for the fluid, if the permeated corrosive gas filled the inside of the flow rate control module 106, the controller 112 or the driver 111 would end up being corroded, the operations of flow measurement and flow rate control would be affected and therefore accurate flow rate control would no longer become possible or, in the worst case, the module would break. At this time, even if the breakdown of the module was due to corrosion of the controller 112 or driver 111, since the flow rate control module 106 was designed predicated on the parts being assembled integrally, there was the problem that repair or replacement of individual parts was difficult, so the module itself had to be replaced and the cost for repair of damage ended up becoming high. Further, when the fluid flowing into the fluid control system was a flow pulsating with a fast pressure fluctuation period, the control valve 108 operated so as to control the flow rate with respect to the pulsating fluid, but there was the problem that hunting occurred and the flow rate could no longer be controlled. If continuing operation in this state, there was the problem that the driver 111 or the control valve 108 would end up being damaged.

The present invention was made in consideration of the above problems in the conventional art and has as its object the provision of a fluid control system with easy installation in a semiconductor production system etc. and pipe and wiring connections, with reduced pressure loss due to pipe connections, with easy change of arrangement of modules, free from corrosion even using a corrosive fluid for the fluid, and enabling control of the flow rate even with pulsation of the inflowing fluid.

Explaining the configuration of the fluid control system of the present invention for solving the above problem based on FIG. 1 to FIG. 9, as a first aspect, there is provided a system provided with a flowmeter sensor part (4;204) having an ultrasonic oscillator (12, 13;212, 213) generating an ultrasonic wave in a fluid and an ultrasonic oscillator (12, 13;212, 213) receiving the ultrasonic wave generated from the ultrasonic oscillator (12, 13;212, 213) and outputting a signal to a flowmeter amplifier (64;282) and a control valve (5;205) controlling the state of flow of fluid to a predetermined state by a working pressure, characterized in that at least the flowmeter sensor part (4;204) and the control valve (5;205) are connected inside a single first casing (2;202) having a fluid inlet (3;203) and a fluid outlet (6;206). Here, the “state of flow of fluid” means, for example, the state of flow of fluid which can be defined by a quantitative parameter such as pressure or flow rate. Accordingly, “controlling the state of flow of fluid to a predetermined state” means controlling the desired quantitative parameter in the flow of fluid to a predetermined amount.

As a second aspect, the control valve is a pressure control valve 5 controlling the pressure of the flow of fluid to a predetermined pressure by the working pressure.

As a third aspect, the system is provided with a valve module 1 comprised of the flowmeter sensor part 4 and the pressure control valve 5 set in a single first casing 2 and an electrical component module 62 comprised of a flowmeter amplifier 64 calculating a flow rate by the signal of the flowmeter sensor part 4, an electro-pneumatic converter 66 adjusting the working pressure of the pressure control valve 5, and a controller 65 for adjusting the working pressure and performing feedback control based on the value of the flow rate calculated by the flowmeter amplifier 64 set in a single second casing 63, the valve module 1 and the electrical component module 62 being comprised of separate members.

As a fourth aspect, the second casing 63 of the electrical component module 62 is formed with an exhaust port (73) provided so as to exhaust a gas filled in the second casing 63.

As a fifth aspect, the pressure control valve 5 is provided with a main body 14 having a second cavity 22 provided opened at a bottom center to a bottom, an inlet channel 24 communicating with the second cavity 22, a first cavity 23 provided opened at a top surface to the top and having a diameter larger than a diameter of the second cavity 22, an outlet channel 25 communicating with the first cavity 23, and a communicating hole 26 connecting the first cavity 23 and second cavity 22 and having a diameter smaller than the diameter of the first cavity 23, the top surface of the second cavity 22 being made a valve seat 27; a bonnet 15 having a cylindrical cavity 28 inside it and provided with a step difference 29 at the inside periphery of the bottom end; a feed hole 30 provided on a side surface or top surface of the bonnet 15 and feeding a pressurized gas into the cylindrical cavity 28; a spring receiver 16 inserted into the step difference 29 of the bonnet 15 and having a through hole 32 at the center part; a piston 17 having a first engagement part 37 having a smaller diameter than the through hole 32 of the spring receiver 16 at the bottom end, provided with a flange 35 at the top, and inserted into the cavity 28 of the bonnet 15 to enable vertical movement; a spring 18 held and supported between a bottom end face of the flange 35 of the piston 17 and a top end face of the spring receiver 16; a first valve mechanism 19 having a first diaphragm 40 with a periphery fastened held between the main body 14 and spring receiver 16 and with a thick center part forming a first valve chamber 44 in a form capping the first cavity 23 of the main body 14, a second engagement part 42 fastened connected to the first engagement part 37 of the piston 17 and passing through the through hole 32 of the spring receiver 16 at the center of the top surface, and a third engagement part 43 provided passing through a communicating hole 26 of the main body 14 at the center of the bottom surface; a second valve mechanism 20 having a valve element 45 positioned inside the second cavity 22 of the main body 14 and provided with a larger diameter than the communicating hole 26 of the main body 14, a fourth engagement part 47 provided projecting out at the top end face of the valve element 45 and fastened connected to the third engagement part 43 of the first valve mechanism 19, and a rod 48 provided projecting out from the bottom end face of the valve element 45 and a second diaphragm 50 provided extending from the bottom end face of the rod 48 in the diametrical direction; and a base plate 21 positioned below the main body 14, having a projecting part 52 holding and fastening the periphery of the second diaphragm 50 of the second valve mechanism 20 with the main body 14 at the top center, provided with a cut recess 53 at the top end of the projecting part 52, and provided with a breathing hole 54 communicating with the cut recess 53; the opening area of the fluid controller 55 formed by the valve element 45 of the second valve mechanism 20 and the valve seat 27 of the main body 14 changing along with vertical movement of the piston 17.

As a sixth aspect, cables 70, 71 connecting the flowmeter sensor part 4 and flowmeter amplifier 64 are provided detachably through connectors 59, 60, 67, 68 to the flowmeter sensor part 4 and/or flowmeter amplifier 64.

As a seventh aspect, cables 70, 71 connecting the flowmeter sensor part 4 and flowmeter amplifier 64 are provided detachably through connectors 59, 60, 67, 68 to the flowmeter sensor part 4 and/or flowmeter amplifier 64, a side surface or top surface of the bonnet 15 of the pressure control valve 5 is provided with an exhaust hole 31 for exhausting a gas from the inside of the cylindrical cavity 28, the exhaust hole 31 is communicated with an intake hole 57 of a connector box 56 provided at the first casing 2, and the connector box 56 is provided with an exhaust hole 58 communicated with the outside of the first casing 2.

As an eighth aspect, the flowmeter sensor part 4 is a flowmeter sensor part 4 provided successively with an inlet channel 7 communicating with the fluid inlet 3, a first rising channel 8 vertically provided from the inlet channel 7, a straight channel 9 communicating with the first rising channel 8 and provided approximately parallel to an axis of the inlet channel 7, a second rising channel 10 vertically provided from the straight channel 9, and an outlet channel 11 communicating with the second rising channel 10, provided approximately parallel to the axis of the inlet channel 7, and communicating with the inlet channel 24 of the pressure control valve 5, the ultrasonic oscillators 12, 13 arranged facing each other at positions where side walls of the first and second rising channels 8, 10 intersect the axis of the straight channel 9; and the flowmeter amplifier 64 is a flowmeter amplifier 64 to which the ultrasonic oscillators 12, 13 are connected through cables 70, 71; and the flowmeter sensor part 4 and the flowmeter amplifier 64 form an ultrasonic wave flowmeter which alternately switches between transmission and reception of the ultrasonic oscillators 12, 13 and measures the difference in propagation times of ultrasonic waves between the ultrasonic oscillators 12, 13 so as to calculate the flow rate of fluid running through the straight channel 9.

As a ninth aspect, the flowmeter sensor part 74 is a flowmeter sensor part 74 successively provided with an inlet channel 77 communicated with the fluid inlet 3, a vortex generator 78 provided vertically in the inlet channel 77 and generating a Karman vortex, and an outlet channel 79 in a straight channel 80, the ultrasonic oscillators 81, 82 being arranged facing each other at positions where side walls at the downstream side of the vortex generator 78 of the straight channel 80 perpendicularly intersect the channel axial direction; the flowmeter amplifier 86 is a flowmeter amplifier 86 to which the ultrasonic oscillators 81, 82 are connected through cables 92, 93; and the flowmeter sensor part 74 and the flowmeter amplifier 86 form an ultrasonic wave type vortex flowmeter calculating the flow rate by the phase difference between the signal of the ultrasonic oscillator 81 transmitting the frequency of the Karman vortex generated downstream of the vortex generator 78 and the signal received by the ultrasonic oscillator 82.

As a 10th aspect, the control valve is a constant flow valve 205 controlling the flow rate of the flow of fluid to a predetermined flow rate by its working pressure.

As an 11th aspect, the system is provided with a valve module 201 comprised of the flowmeter sensor part 204 and the constant flow valve 205 arranged at a single first casing 202 and an electrical component module 280 comprised of a flowmeter amplifier 282 for calculating the flow rate by the signal of the flowmeter sensor part 204, an electro-pneumatic converter 284 for adjusting the working pressure of the constant flow valve 205, and a controller 283 for adjusting the working pressure based on the value of the flow rate calculated by the flowmeter amplifier 282 for feedback control arranged in a single second casing 281, the valve module 201 and the electrical component module 280 being comprised of separate members.

As a 12th aspect, the second casing 281 of the electrical component module 280 is formed with an exhaust port 291 provided for exhausting a gas filled in the second casing 281.

As a 13th aspect, the constant flow valve 205 has a main body part (214) formed from an inlet channel (238) and outlet channel (245) of the fluid and a chamber (220) communicated with the inlet channel (238) and outlet channel (245), a valve member 229 having a valve element 258 and first diaphragm part 230, and a second diaphragm part 231 and a third diaphragm part 232 positioned at the bottom and top of the valve member 229 and having a smaller effective pressure receiving area than the first diaphragm part 230; the valve member 229 and diaphragm parts 230, 231, 232 are attached inside the chamber 220 so that the outer peripheries of the diaphragm parts 230, 231, 232 are fastened at the main body part 214 and the diaphragm parts 230, 231, 232 divide the chamber 220 into a first pressurizing chamber 221, a second valve chamber 222, a first valve chamber 223, and a second pressurizing chamber 224; the first pressurizing chamber 221 has a means for constantly applying a certain inwardly directed force to the second diaphragm part 231; the first valve chamber 223 is communicated with the inlet channel 238; the second valve chamber 222 has a valve seat 243 corresponding to the valve element 258 of the valve member 229, further is formed divided into a bottom second valve chamber 225 positioned at the first diaphragm part 230 side with respect to the valve seat 243 and communicated with the first valve chamber 223 by a communicating hole 255 provided at the first diaphragm part 230 and a top second valve chamber 226 positioned at a second diaphragm part 231 side and provided communicating with the outlet channel 245, and having a fluid controller 261 changing in opening area between the valve element 258 and the valve seat 243 by vertical movement of the valve member 229 and thereby controlled in fluid pressure of the bottom second valve chamber 225; and the second pressurizing chamber 224 has a means for constantly applying a certain inwardly directed force to the third diaphragm part 232.

As a 14th aspect, cables 288, 289 connecting the flowmeter sensor part 204 and flowmeter amplifier 282 are provided detachably through connectors 277, 278, 285, 286 to the flowmeter sensor part 204 and/or flowmeter amplifier 282.

As a 15th aspect, cables 288, 289 connecting the flowmeter sensor part 204 and flowmeter amplifier 282 are provided detachably through connectors 277, 278, 285, 286 to the flowmeter sensor part 204 and/or flowmeter amplifier 282; a side surface or top surface of the main body part 214 of the constant flow valve 205 is provided with a feed hole 250 for feeding pressurized gas into the first pressurizing chamber 221 and an exhaust hole 273 exhausting the gas from the inside of the first pressurizing chamber 221; and the exhaust hole 273 is communicated with an intake hole 275 of a connector box 274 provided at the first casing 202, and the connector box 274 is provided with an exhaust hole 276 communicated with the outside of the first casing 202.

As a 16th aspect, the flowmeter sensor part 204 is a flowmeter sensor part 204 provided successively with an inlet channel 207 communicating with the fluid inlet 203, a first rising channel 208 vertically provided from the inlet channel 207, a straight channel 209 communicating with the first rising channel 208 and provided approximately parallel to the axis of the inlet channel 207, a second rising channel 210 vertically provided from the straight channel 209, and an outlet channel 211 communicating with the second rising channel 210, provided approximately parallel to the axis of the inlet channel 207, and communicating with the inlet channel 238 of the constant flow valve 205, the ultrasonic oscillators 212, 213 being arranged facing each other at positions where side walls of the first and second rising channels 208, 210 intersect the axis of the straight channel 209; and the flowmeter amplifier 282 is a flowmeter amplifier 282 to which the ultrasonic oscillators 212, 213 are connected through cables 288, 289; and the flowmeter sensor part 204 and the flowmeter amplifier 282 form an ultrasonic wave flowmeter which alternately switches between transmission and reception of the ultrasonic oscillators 212, 213 and measures the difference in propagation times of ultrasonic waves between the ultrasonic oscillators 212, 213 so as to calculate the flow rate of fluid running through the straight channel 209.

As a 17th aspect, the flowmeter sensor part 292 is a flowmeter sensor part 292 successively provided with an inlet channel 295 communicated with the fluid inlet 203, a vortex generator 296 provided vertically in the inlet channel 295 and generating a Karman vortex, and an outlet channel 297 in a straight channel 298, the ultrasonic oscillators 299, 300 being arranged facing each other at positions where side walls at the downstream side of the vortex generator 296 of the straight channel 298 perpendicularly intersect the channel axial direction; the flowmeter amplifier 304 is a flowmeter amplifier 304 to which the ultrasonic oscillators 299, 300 are connected through cables 310, 311; and the flowmeter sensor part 292 and the flowmeter amplifier 304 form an ultrasonic wave type vortex flowmeter calculating the flow rate by the phase difference between the signal of the ultrasonic oscillator 299 transmitting the frequency of the Karman vortex generated downstream of the vortex generator 296 and the signal received by the ultrasonic oscillator 300.

In the present invention, at least the flowmeter sensor part (4;204) and the control valve (5;205) controlling the state of the flow to a predetermined state by the working pressure may be connected inside the single casing (2;202). By the flowmeter sensor part (4;204) and the control valve (5;205) being made integral, the flow rate control system can be provided compactly, the pipe connection becomes easy, and the parts connected by couplings etc. are reduced, so the pressure loss due to the connected parts can be reduced.

When the control valve is a pressure control valve 5, since the pressure control valve 5 can control the fluid to a constant pressure, even if the inflowing fluid is a flow pulsating with a fast pressure fluctuation period, stable pressure control becomes possible without hunting occurring. By combination with the flowmeter sensor part 4, the flow rate of the fluid flowing out from the pressure control valve 5 is determined by the pressure regulated by the pressure control valve 5 and the pressure loss from the pressure control valve 5 on and is controlled by the pressure control valve 5 so that the flow rate becomes a constant value by the set flow rate.

In the present invention, the pressure control valve 5 is not particularly limited so long as it can control the pressure by the working pressure, but having the configuration of the pressure control valve 5 of the present invention is preferable. This is because the compressed air from the feed hole 30 is constantly supplied to inside of the cavity 28 of the bonnet 15 and is constantly exhausted from the exhaust hole 31, so when using a corrosive fluid for the fluid, even if corrosive gas permeates to the inside of the cavity 28, it is exhausted riding the flow of air from the feed hole 30 to the exhaust hole 31 and will not easily build up inside the cavity 28. Therefore, among the parts of the pressure control valve 5, corrosion of the corrodible spring 18 can be prevented, there is no longer a need for corrosion-prevention coating etc., and the valve can be inexpensively produced. In addition, since there is also no change in the spring constant due to coating, it is possible to keep individual differences small and possible to improve the yield. Further, the valve is compact in structure and stable fluid pressure control can be obtained.

When the control valve is a constant flow valve 205, since the constant flow valve 205 can control the flow rate constant, even if the inflowing fluid is a flow pulsating with a fast pressure fluctuation period, stable flow rate control becomes possible without hunting occurring. By combination with the flowmeter sensor part 204, the flow rate of the fluid flowing out from the constant flow valve 205 is controlled by the constant flow valve 5 so as to become a constant value by the set flow rate.

In the present invention, the constant flow valve 205 is not particularly limited so long as it can control the flow rate by the working pressure, but preferably has the configuration of the constant flow valve 205 of the present invention. This is because it is possible to change the flow rate by changing the inwardly directed force from the pressurizing means of the first pressurizing chamber 221, so it is possible to change the flow rate without disassembling the valve. Further, by adjusting the inwardly directed force from the pressurizing means of the first pressurizing chamber 221 to become smaller than the inwardly directed force from the pressurizing means of the second pressurizing chamber 224, it is possible to cut off the fluid, so there is no need to connect a separate fluid cutoff valve and the flow rate can be set after laying the pipes. Further, the value is compact in structure and stable flow rate control can be obtained, so this is preferable. Further, if the pressurizing means of the first pressurizing chamber 221 and second pressurizing chamber 224 of the present invention is one biasing the upward direction or downward direction force, it may be compressed air, a spring, etc. and is not particularly limited, but if compressed air, it is not necessary to use a corrodible metal part for the constant flow valve 205, so use is possible without concern over corrosion. Further, when using a spring, the spring is preferably coated by a fluororesin. The coating prevents corrosion.

Further, in the present invention, the flowmeter sensor part (4;204) of the valve module (1;201) and the flowmeter amplifier (64;282) of the electrical component module (62;280) may be directly connected by cables (70, 71;288, 289), but it is preferable to connect the flowmeter sensor part (4;204) and the flowmeter amplifier (64;282) by cables (70, 71;288, 289) through connectors (59, 60;277, 278) connected to the flowmeter sensor part (4;204) and connectors (67, 68;285, 286) connected to the flowmeter amplifier (64, 282). At this time, just the connectors (59, 60;277, 278) connected to the flowmeter sensor part (4;204) may be provided, just the connectors (67, 68;285, 286) connected to the flowmeter amplifier (64;282) may be provided, or both may be provided. By connection through connectors, the wiring of the fluid control system becomes only connection of connectors and can be performed easily in a short time. Further, since connectors are detachable, detachment of the wiring also becomes easy, so the layout of modules can be easily changed.

Further, the casing (2;202) of the valve module (1;201) of the present invention may also be provided with a connector box (56;274). The inert gas or air exhausted from the exhaust hole (31;273) of the control valve (5;205) is supplied from the intake hole (57;275) of the connector box (56;274) to the inside of the connector box (56;274) and is exhausted from the exhaust hole (58;276), so when using a corrosive fluid for the fluid, even if the corrosive gas permeates to the inside of the connector box (56;274), it is exhausted riding the flow of air from the intake hole (57;275) to the exhaust hole (58;276) and will not easily build up in the connector box (56;274). Due to this, corrosion of corrodible connectors (59, 60;277, 278) is prevented.

Further, the flow measuring device comprised of the flowmeter sensor part (4;204) and flowmeter amplifier (64;282) of the present invention is not particularly limited so long as it converts the measured flow rate to an electrical signal and outputs it to the controller (65;283), but an ultrasonic wave flowmeter or an ultrasonic wave type vortex flowmeter is preferable. In particularly, having the configuration of an ultrasonic wave flowmeter or ultrasonic wave type vortex flowmeter of the present invention is more preferable. In the case of the ultrasonic wave flowmeter of the present invention, a fine flow rate can be measured with a good precision, so this is suitable for fluid control with a fine flow rate. Further, in the case of the ultrasonic wave type vortex flowmeter of the present invention, a large flow rate can be measured with a good precision, so this is suitable for fluid control with a large flow rate. In this way, it is possible to selectively use an ultrasonic wave flowmeter and ultrasonic wave type vortex flowmeter in accordance with the flow rate of the fluid for fluid control with a good precision.

Further, the casing (2;202), fluid inlet (3;203), the flowmeter sensor part (4;204) other than ultrasonic oscillators (12, 13;212, 213), each parts of control valve (5;205), the fluid outlet (6;206), and the casing (63;281) of the electrical component module (62;280) of the present invention may be made of any plastic such as polyvinyl chloride, polypropylene, polyethylene, etc., but in particular when using a corrosive fluid for the fluid, polytetrafluoroethylene (hereinafter referred to as “PTFE”), polyvinylidene fluoride (hereinafter referred to as “PVDF”), a tetrafluoroethylene-perfluoroalkylvinyl ether copolymer resin (hereinafter referred to as “PFA”), or other fluororesin is preferable. If made of a fluororesin, even if corrosive gas permeates, there is no concern over the parts corroding.

Further, the valve module (1;201) of the present invention is provided with a fluid inlet (3;203), flowmeter sensor part (4;204), control valve (5;205), and fluid outlet (6;206), but it may also be provided with a shutoff valve, thermometer, or other piping member so long as not liable to corrode. Further, the electrical component module (62;280) is provided with a flowmeter amplifier (64;282), controller (65;283), and electro-pneumatic converter (66;284), but it may also be provided with other electrical components.

The present invention has the above structure and gives the following excellent effects:

(1) Since the flowmeter sensor part and the control valve for controlling the state of flow of fluid to a predetermined state by the working pressure are connected in a single casing, the flow rate control system can be provided compactly, the pipe connection becomes easy, and the parts connected by couplings etc. are reduced, so the pressure loss due to the connection parts can be reduced. When the control valve is a pressure control valve, even if the inflowing fluid is a flow pulsating with a fast pressure fluctuation period, stable pressure control becomes possible without hunting occurring. When the control valve is a constant flow valve, even if the inflowing fluid is a flow pulsating with a fast pressure fluctuation period, stable flow rate control becomes possible without hunting occurring.

(2) By the valve module and the electrical component module being configured separated into two, when using a corrosive fluid for the fluid, even if corrosive gas permeates, the electrical component module having corrodible parts is isolated from the valve module through which the corrosive fluid flows, so will not be corroded.

(3) By the parts for performing the fluid control being configured separated into two arranged in the valve module and electrical component module and the wiring connected detachably through connectors, it is possible to set them inside the semiconductor production system etc., easily connect the pipes and wiring, and perform the work in a short time. Detachment is also easy and the layout of the modules can be easily changed.

(4) By using the pressure control valve of the configuration of the present invention, stable fluid pressure control becomes possible by a compact structure. Further, since it constantly exhausts compressed air in the cavity, the permeating corrosive gas will not corrode the spring, so measures such as coating of the spring become unnecessary, and the valve can be produced inexpensively.

(5) By using the constant flow valve of the configuration of the present invention, stable flow rate control becomes possible by a compact structure. Further, it is possible to change the inwardly directed force from the pressurizing means of the first pressurizing chamber so as to change the flow rate, so it is possible to change the flow rate without disassembling the valve. Further, if adjusting the inwardly directed force from the pressurizing means of the first pressurizing chamber to become smaller than the inwardly directed force from the pressurizing means of the second pressurizing chamber, it is possible to cut off the fluid, so it is not necessary to connect a separate fluid cutoff valve and the flow rate can be set after laying the pipes.

(6) By using the ultrasonic wave flowmeter of the configuration of the present invention, when fluid flows by a fine flow rate, accurate, stable fluid control becomes possible.

(7) By using the ultrasonic wave type vortex flowmeter of the configuration of the present invention, when fluid flows by a large flow rate, accurate, stable fluid control becomes possible.

### BRIEF DESCRIPTION OF THE DRAWINGS

FIG. 1 is a longitudinal cross-sectional view of a fluid control system showing a first embodiment of the present invention.

FIG. 2 is an enlarged view of principal parts of a pressure control valve of FIG. 1.

FIG. 3 is a longitudinal cross-sectional view of a fluid control system showing a second embodiment of the present invention.

FIG. 4 is a cross-sectional view along the line A-A of FIG. 3.

FIG. 5 is a longitudinal cross-sectional view of a fluid control system showing a third embodiment of the present invention.

FIG. 6 is an enlarged view of principal parts of a constant flow valve of FIG. 5.

FIG. 7 is a view the same as FIG. 6 comprised of FIG. 6 plus further illustration.

FIG. 8 is a longitudinal cross-sectional view of a fluid control system showing a fourth embodiment of the present invention.

FIG. 9 is a cross-sectional view along the line A-A of FIG. 8.

FIG. 10 is a conceptual view of the configuration showing a conventional control system of a pure water flow rate.

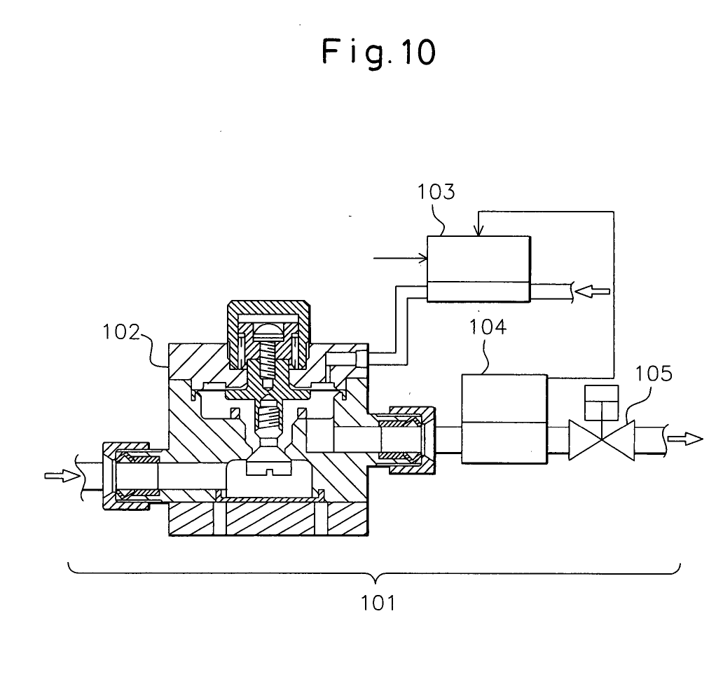

FIG. 11 is a partial cross-sectional view showing a conventional fluid control module.

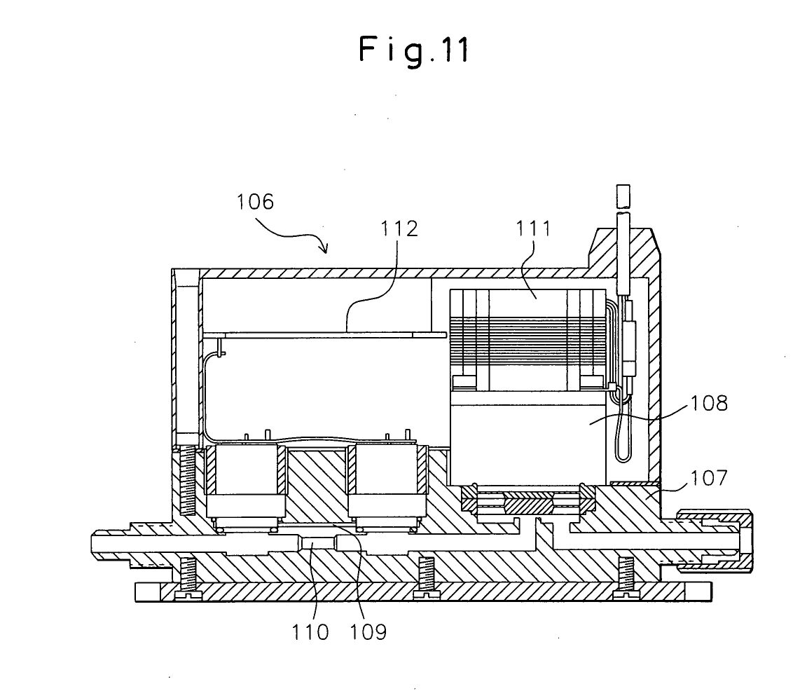

### BEST MODE FOR WORKING THE INVENTION

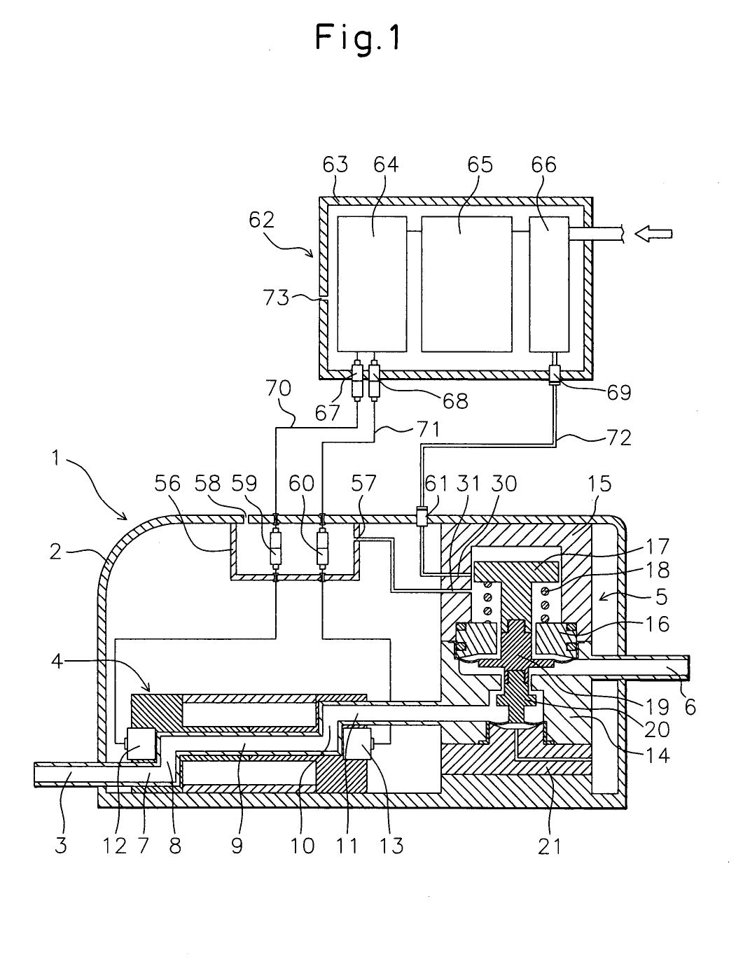

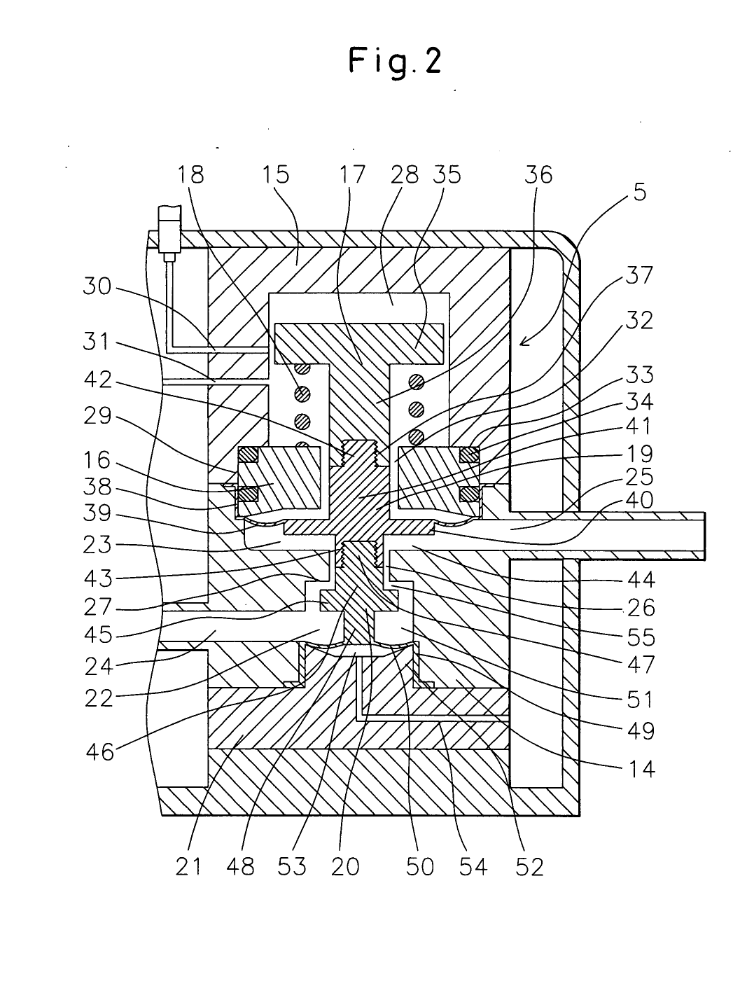

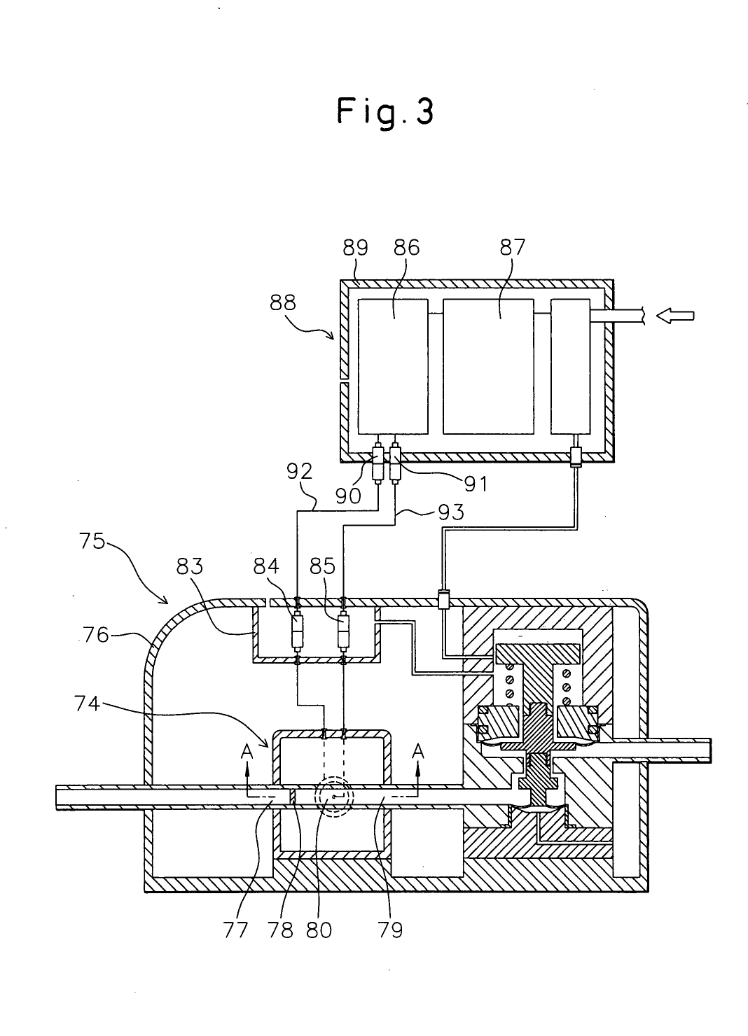

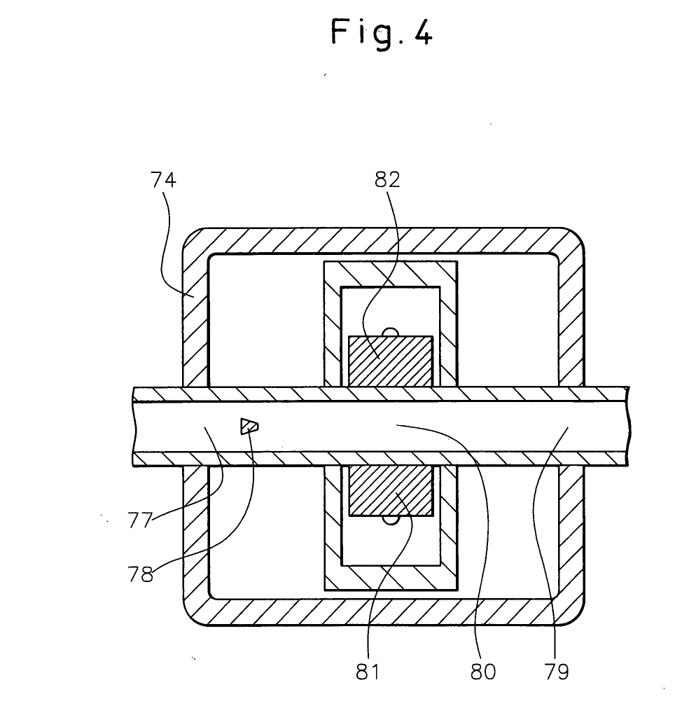

Below, first and second embodiments of the present invention will be explained with reference to FIG. 1 to FIG. 4, but the present invention is not limited to the present embodiments. FIG. 1 is a longitudinal cross-sectional view of a fluid control system showing a first embodiment of the present invention. FIG. 2 is an enlarged view of principal parts of a pressure control valve of FIG. 1. FIG. 3 is a longitudinal cross-sectional view of a fluid control system showing a second embodiment of the present invention. FIG. 4 is a cross-sectional view along the line A-A of FIG. 3.

Below, a fluid control system of a first embodiment of the present invention will be explained based on FIG. 1 and FIG. 2.

1 is a valve module. The valve module 1 is formed from a casing 2, fluid inlet 3, flowmeter sensor part 4, pressure control valve 5, and fluid outlet 6. Each is configured as follows:

2 is a PVDF casing. In the casing 2, the flowmeter sensor part 4 and pressure control valve 5 are fastened by bolts and nuts (not shown) to the bottom of the casing 2. The fluid inlet 3, flowmeter sensor part 4, pressure control valve 5, and fluid outlet 6 are arranged in the state successively connected in that order. Further, the casing 2 is provided with a later explained connector box 56. The connector box 56 is formed so that inert gas or air is supplied from an intake hole 57 and exhausted from an exhaust hole 58. Note that the flowmeter sensor part 4 and the pressure control valve 5 may also be reversed in order.

3 is a PTFE fluid inlet. The fluid inlet 3 is communicated with an inlet channel 7 of the later explained flowmeter sensor part 4.

4 is a flowmeter sensor part measuring the flow rate of the fluid. The flowmeter sensor part 4 has the inlet channel 7 communicating with the fluid inlet 3, a first rising channel 8 vertically provided from the inlet channel 7, a straight channel 9 communicating with the first rising channel 8 and provided approximately parallel to an axis of the inlet channel 7, a second rising channel 10 vertically provided from the straight channel 9, and an outlet channel 11 communicating with the second rising channel 10 and provided approximately parallel to the axis of the inlet channel 7, the ultrasonic oscillators 12, 13 arranged facing each other at positions where side walls of the first and second rising channels 8, 10 intersect the axis of the straight channel 9. The ultrasonic oscillators 12, 13 are covered by a fluororesin, while the wires extending from the oscillators 12, 13 are connected to connectors 59, 60 in the later explained connector box 56. Note that the parts of the flowmeter sensor part 4 other than the ultrasonic oscillators 12, 13 are made of PFA.

5 is a pressure control valve controlling the fluid pressure in accordance with the working pressure. The pressure control valve 5 is formed by the main body 14, bonnet 15, spring receiver 16, piston 17, spring 18, first valve mechanism 19, second valve mechanism 20, and base plate 21.

14 is a PTFE main body. It has a second cavity 22 provided opened at a bottom center to a bottom and a first cavity 23 having a diameter larger than the diameter of the second cavity 22 provided opened at a top surface to the top and has an inlet channel 24 communicating with the second cavity 22 at the side surface and an outlet channel 25 communicating with the first cavity 23 at the surface facing the inlet channel 24. Further, a communicating hole 26 communicating the first cavity 23 and second cavity 22 and having a diameter smaller than the diameter of the first cavity 23 is provided. A top surface of the second cavity 22 is made a valve seat 27. Further, the inlet channel 24 communicates with the outlet channel 11 of the flowmeter sensor part 4, while the outlet channel 25 is communicated with the later explained fluid outlet 6.

15 is a PVDF bonnet. It is provided inside it with a cylindrical cavity 28 and a step difference 29 enlarged in diameter from the cavity 28 at the inside periphery of the bottom end and is provided at its side surface with a feed hole 30 communicating the cavity 28 and the outside for feeding compressed inert gas or air into the cavity 28 and a fine exhaust hole 31 for exhausting a fine amount of the inert gas or air introduced from the feed hole 30.

16 is a PVDF flat circular shaped spring receiver. It has a through hole 32 at its center part and is inserted into the step difference 29 of the bonnet 15 at its substantially top half. The side surface of the spring receiver 16 is provided with a ring-shaped groove 33. By fitting an O-ring 34 there, the outflow of inert gas or air from the bonnet 15 to the outside other than the exhaust of the inert gas or air from the exhaust hole 31 of the bonnet 15 is prevented.

17 is a PVDF piston. It has, at its top, a disk shaped flange 35, a piston shaft 36 provided projecting out from the center bottom of the flange 35 in a columnar shape, and a first engagement part 37 comprised of a female thread provided at the bottom end of the piston shaft 36. The piston shaft 36 is provided with a smaller diameter than the through hole 32 of the spring receiver 16, while the first engagement part 37 is connected by engagement with the second engagement part 42 of the later explained first valve mechanism 19.

18 is an SUS spring. It is held between the bottom end face of the flange 35 of the piston 17 and the top end face of the spring receiver 16. The spring 18 expands and contracts along with vertical movement of the piston 17, but one with a long free length is preferably used so that the change in load at that time is small.

19 is a PTFE first valve mechanism. It has a first diaphragm 40 having a film part 39 having a tubular part 38 provided projecting out upward from the outer periphery and a thick part at its center part, a second engagement part 42 comprised of a small diameter male thread provided at the top end of a shaft part 41 provided projecting out from the top surface of the center of the first diaphragm 40, and a third engagement part 43 comprised of a female thread provided projecting out from the bottom surface of the center and formed at the bottom end engaged with the fourth engagement part 47 of the later explained second valve mechanism 20. By the tubular part 38 of the first diaphragm 40 being fastened by being held between the main body 14 and spring receiver 16, the first valve chamber 44 formed at the bottom surface of the first diaphragm 40 is formed so that the fluid from the inlet channel 24 of the main body 14 will not flow out from the first valve chamber 44 to the cavity 28 of the bonnet 15. Further, without the compressed inert gar or air supplied to the cavity 28 of the bonnet 15 flowing out to the first valve chamber 44 by the O-ring 34, the top surface of the first diaphragm 40 and the cavity 28 of the bonnet 15 forms a gas chamber in which compressed inert gas or air supplied from the feed hole 30 of the bonnet 15 is filled.

20 is a PTFE second valve mechanism. It is comprised of a valve element 45 provided inside the second cavity 22 of the main body 14 and provided with a larger diameter than the communicating hole 26, a shaft part 46 provided projecting out from the top end face of the valve element 45, a fourth engagement part 47 comprised of a male thread part provided at its top end and fastened by connection by screwing with the third engagement part 43, a rod 48 provided projecting out from the bottom end face of the valve element 45, and a second diaphragm 50 provided extending from the bottom end face of the rod 48 in the diametrical direction and having a tubular projection 49 provided projecting from the periphery downward. By the tubular projection 49 of the second diaphragm 50 being fastened by being held between the projecting part 52 of the later explained base plate 21 and the main body 14, the second valve chamber 51 formed by the second cavity 22 of the main body 14 and the second diaphragm 50 is formed so that the fluid from the inlet channel 24 of the main body 14 does not flow out from the second valve chamber 51 to the cut recess 53 of the base plate 21.

21 is a PVDF base plate. It has a projecting part 52 fastening the tubular projection 49 of the second diaphragm 50 of the second valve mechanism 20 by holding it with the main body 14 at its top center, is provided with a cut recess 53 at the top end of the projecting part 52, is provided with a breathing hole 54 communicating with the cut recess 53 at the side surface, and fastens the main body 14 with the bonnet 15 by holding by bolts and nuts (not shown).

6 is a PTFE fluid outlet.

56 is a PVDF connector box provided at the casing 2. The connector box 56 is provided with an intake hole 57 communicating with the inside of the casing 2 and an exhaust hole 58 communicating with the outside of the casing 2. The intake hole 57 is connected through a tube with the exhaust hole 31 of the pressure control valve 5. The connector box 56 is formed to be supplied with compressed inert gas or air from the intake hole 57 and to exhaust it from the exhaust hole 58. Inside the connector box 56 are arranged connectors 59, 60 connected with wires extending from the ultrasonic oscillators 12, 13. The connectors 59, 60 are detachably connected to the connectors of the cables 70, 71 connected with wires extending from the flowmeter amplifier 64 of the later explained electrical component module 62.

Further, in the casing 2, an air connector 61 connected to a pipe extending to the feed hole 30 of the pressure control valve 5 is fastened by the connection part projecting out from the outer surface of the casing 2.

62 is an electrical component module. The electrical component module 62 is formed from a casing 63, flowmeter amplifier 64, controller 65, and electro-pneumatic converter 66. These are configured as follows:

63 is a PVDF casing. Inside the casing 63, the flowmeter amplifier 64, controller 65, and electro-pneumatic converter 66 are set. Further, the casing 63 is supplied with inert gas or air from the outside to the electro-pneumatic converter 66. The casing 63 is provided with an exhaust port 73, and the casing 63 is supplied with compressed air from the electro-pneumatic converter 66 to the inside of the casing 63. The casing 63 is formed so that compressed air supplied from the electro-pneumatic converter 66 to the inside of the casing 63 is exhausted from the exhaust port 73.

64 is a flowmeter amplifier. The flowmeter amplifier 64 has a processor calculating the flow rate from the signal output from the flowmeter sensor part 4. The processor is provided with a transmission circuit outputting ultrasonic vibration of a certain period to the transmitting side ultrasonic oscillator 12, a reception circuit receiving the ultrasonic vibration from the receiving side ultrasonic oscillator 13, a comparison circuit comparing the propagation times of the ultrasonic vibrations, and a processing circuit calculating the flow rate from the difference of propagation times output from the comparison circuit.

65 is a controller. The controller 65 has a control circuit performing feedback control so that the flow rate output from the flowmeter amplifier 64 becomes the set flow rate and controlling the working pressure of the later explained electro-pneumatic converter 66.

The 66 is an electro-pneumatic converter adjusting the working pressure of the inert gas or air. The electro-pneumatic converter 66 is comprised of a solenoid valve electrically driving the device so as to proportionally adjust the working pressure and adjusts the working pressure of the pressure control valve 5 in accordance with the control signal from the controller 65.

Further, the casing 63 has connectors 67, 68 connected to wires extending from the flowmeter amplifier 64 fastened so that the connection parts project out from the outer surface of the casing 63. Similarly, the air connector 69 connected to a pipe extending from the electro-pneumatic converter 66 is fastened so that the connection part projects out from the outer surface of the casing 63.

The valve module 1 and the electrical component module 62 are configured separately as two parts by detachably connecting the connectors of the cables 70, 71 to the connectors 59, 60, 67, 68 of the modules 1, 62 and detachably connecting the tube 72 to the air connectors 61, 69 of the modules 1, 62. Note that in the present invention, there were two cables, but these may also be bundled into one. In this case, the modules 1, 62 are also provided with one connector each.

Next, the operation of the fluid control system of a first embodiment of the present invention will be explained.

The fluid flowing in from the fluid inlet 3 of the valve module 1 flow to the first flowmeter sensor part 4.

The fluid flowing into the flowmeter sensor part 4 is measured for flow rate at the straight channel 9. Ultrasonic vibration is propagated from the ultrasonic oscillator 12 positioned at the upstream side in the flow of fluid toward the ultrasonic oscillator 13 positioned at the downstream side. The ultrasonic vibration received at the ultrasonic oscillator 13 is converted to an electrical signal which is output to the processor of the flowmeter amplifier 64. When the ultrasonic vibration is received propagated from the upstream side ultrasonic oscillator 12 to the downstream side ultrasonic oscillator 13, transmission and reception are switched instantaneously inside the processor and ultrasonic vibration is propagated from the ultrasonic oscillator 13 positioned at the downstream side toward the ultrasonic oscillator 12 positioned at the upstream side. The ultrasonic vibration received at the ultrasonic oscillator 12 is converted to an electrical signal which is output to the processor of the flowmeter amplifier 64. At this time, the ultrasonic vibration is propagated against the flow of fluid inside the straight channel 9, so compared with when propagating ultrasonic vibration from the upstream side to the downstream side, the speed of propagation of the ultrasonic vibration in the fluid is slowed and the propagation time becomes longer. The output electrical signals are measured for propagation time in the processor of the flowmeter amplifier 64 and the flow rate is calculated from the difference of propagation times. The flow rate calculated at the flowmeter amplifier 64 is converted to an electrical signal which is output to the controller 65.

Next, the fluid running through the flowmeter sensor part 4 flows into the pressure control valve 5. The controller 65 outputs a signal to the electro-pneumatic converter 66 so as to make the difference between the flow rate measured in real time from any set flow rate zero. The electro-pneumatic converter 66 supplies a working pressure corresponding to this to the pressure control valve 5 to drive it. The flow rate of the fluid from the pressure control valve 5 is determined by the pressure adjusted by the pressure control valve 5 and the pressure loss of the pressure control valve 5 on. The higher the adjusted pressure, the larger the flow rate. Conversely, the lower the pressure, the smaller the flow rate. For this reason, the fluid is controlled by the pressure control valve 5 so that the flow rate becomes a constant value at the set flow rate, that is, the difference between the set flow rate and the measured flow rate converges to zero.

Here, the operation of the pressure control valve 5 with respect to the working pressure supplied from the electro-pneumatic converter 66 will be explained. In the valve element 45 of the second valve mechanism 20, the resiliency of the spring 18 held between the flange 35 of the piston 17 and the spring receiver 16 and the force biasing the first valve mechanism 19 upward by the fluid pressure of the bottom surface of the first diaphragm 40 act and the force biasing it downward by the pressure of the working pressure of the top surface of the first diaphragm 40 acts. More strictly, the bottom surface of the valve element 45 and the top surface of the second diaphragm 50 of the second valve mechanism 20 receive fluid pressure, but their pressure receiving areas are made substantially equal, so the forces are substantially cancelled out. Therefore, the valve element 45 of the second valve mechanism 20 stops at the position where the above three forces balance.

Here, if increasing the working pressure supplied from the electro-pneumatic converter 66, the increase in the force pushing the first diaphragm 40 downward causes the opening area of the fluid controller 55 formed between the valve seat 27 and the valve element of the second valve mechanism 20 to increase, so the pressure of the first valve chamber 44 can be increased. Conversely, if reducing the working pressure, the opening area of the fluid controller 55 falls and the pressure also falls. For this reason, it is possible to adjust the working pressure to set any pressure.

In this state, when the upstream side fluid pressure increases, the pressure inside the first valve chamber 44 also instantaneously increases. This being so, the force received by the bottom surface of the first diaphragm 40 from the fluid becomes larger than the force received by the top surface of the first diaphragm 40 from the compressed air by the working pressure and the first diaphragm 40 moves upward. Along with this, the position of the valve element 45 also moves upward, so the opening area of the fluid controller 55 formed with the valve seat 27 decreases and the pressure inside the first valve chamber 44 is also decreased. Finally, the position of the valve element 45 moves to and stops at the position where the above three forces balance. At this time, if the load of the spring 18 does not greatly change, the pressure inside the cavity 28, that is, the force received by the top surface of the first diaphragm 40 is constant, the pressure received by the bottom surface of the first diaphragm 40 becomes substantially constant. Therefore, the fluid pressure of the bottom surface of the first diaphragm 40, that is, the pressure inside the first valve chamber 44, becomes the same as the original pressure before the increase in the upstream side pressure.

When the upstream side fluid pressure falls, the pressure inside the first valve chamber 44 instantaneously falls. This being so, the force received by the bottom surface of the first diaphragm 40 from the fluid becomes smaller than the force received by the top surface of the first diaphragm 40 from the air compressed by the working pressure and the first diaphragm 40 moves downward. Along with this, the position of the valve element 45 also moves downward, so the opening area of the fluid controller 55 formed with the valve seat 27 increases and the fluid pressure of the first valve chamber 44 increases. Finally, the position of the valve element 45 moves to and stops at the position where the above three force balance. Therefore, in the same way as when the upstream side pressure increases, the fluid pressure in the first valve chamber 44 becomes substantially the same as the original pressure.

By the above operation, the fluid flowing into the fluid inlet 3 of the valve module 1 is controlled to be constant at the set flow rate and flows out from the fluid outlet 6. The ultrasonic wave flowmeter comprised of this flowmeter sensor part 4 and flowmeter amplifier 64 measures the flow rate from the difference of the propagation times in the direction of the flow of fluid, so can accurately measure the flow rate even if a fine flow rate. Further, the pressure control valve 5 exhibits superior effects in fluid control of a fine flow rate since the above configuration enables a compact structure and stable fluid pressure control. Further, even if the upstream side pressure of the fluid flowing into the fluid inlet 3 of the valve module 1 fluctuates, the pressure control valve 5 operates so that the flow rate is autonomously kept constant, so even if pulsation or other instantaneous pressure fluctuations of the pump occur, stable control of the flow rate is possible. Further, since the parts of the valve module 1 are set assembled together inside the casing, the pressure loss of the connection parts is suppressed to the lowest extent and measurement of the flow with less error becomes possible.

Next, the action when corrosive gas permeates into the valve module when the fluid of the fluid control system of the first embodiment of the present invention is a corrosive fluid will be explained.

The fluid control system of the present invention is configured separated into the valve module 1 and electrical component module 62. The parts in the valve module 1 are made of a fluororesin resistant to corrosion, so there is no concern over corrosion. The ultrasonic oscillators 12, 13 are also covered by a fluororesin, so corrosion can be prevented. Further, the parts in the valve module 1 which may corrode are the spring 18 of the pressure control valve 5 and the connectors 59, 60, but the inside of the cavity 28 of the pressure control valve 5 in which the spring 18 is provided is constantly having the compressed air supplied from the feed hole 30 exhausted from the exhaust hole 31. Further, the inside of the connector box 56 where the connectors 59, 60 are arranged has the compressed air exhausted from the exhaust hole 31 and supplied from the intake hole 57 constantly exhausted from the exhaust hole 58 to outside the casing 2, so the permeated corrosive gas is exhausted riding the flow of air and does not easily build up in the cavity 28 or connector box 56, and corrosion can be prevented.

On the other hand, there are parts which would affect the flow measurement or fluid control if the electrical component module 62 corrodes, but these are configured separated from the valve module 1, so by arrangement at a position not affected by the corrosive gas, corrosion of the parts in the electrical component module 62 can be prevented. Further, the inside of the casing 63 of the electrical component module 62 is constantly having compressed air supplied from the electro-pneumatic converter 66 to the inside of the casing 63 exhausted from the exhaust port 73, so even if the electrical component module 62 is installed at a position affected by the corrosive gas, the permeated corrosive gas is exhausted riding the flow of the air and does not easily build up inside the casing 63, so corrosion of the parts of the electrical component module 62 can be prevented.

Next, the procedure for installation of a fluid control system of the first embodiment of the present invention inside a semiconductor production system will be explained.

First, the valve module 1 is arranged at a predetermined position in a pipeline in the semiconductor production system, the fluid inlet 3 and fluid outlet 6 are connected to pipes of the pipeline, and the valve module 1 is fastened in the semiconductor production system. Further, the electrical component module 62 is set at a predetermined position separated from the pipeline in the semiconductor production system. Next, first connectors of the cables 70, 71 are inserted into the connector box 56 of the valve module 1 and connected to the connectors 59, 60, then other connectors of the cables 70, 71 are connected to the connectors 67, 68 of the electrical component module 62. Next, one end of the tube 72 is inserted into the air connector 61 of the valve module 1, then the other end of the tube 72 is inserted into the air connector 69 of the electrical component module 62. By the above procedure, installation in the semiconductor production system becomes extremely easy, the connection of wires and air pipes becomes just connection of connectors, and the work can be performed easily in a short time. Further, according to the configuration of the present invention, replacement work becomes easy even if part of the fluid control system breaks. Further, when installing a plurality of fluid control systems, the electrical component modules are installed together in the control box, so central management of the fluid control systems of the present invention becomes possible.

Below, a fluid control system of a second embodiment of the present invention will be explained based on FIG. 3 and FIG. 4.

74 is a flowmeter sensor part arranged inside the casing 76 of the valve module 75. The flowmeter sensor part 74 has an inlet channel 77, a vortex generator 78 generating a Karman vortex provided vertically inside the inlet channel 77, and an outlet channel 79 provided in a straight channel 80. The ultrasonic oscillators 81, 82 are arranged facing each other at positions at the side walls of the straight channel 80 at the downstream side of the vortex generator 78 perpendicularly intersecting the channel axial direction. The ultrasonic oscillators 81, 82 are covered by a fluororesin. The wires extending from the oscillators 81, 82 are connected to connectors 84, 85 inside the connector box 83. In the same way as the first embodiment, the connector box 83 is formed so that compressed inert gas or air is supplied from its own intake hole and is exhausted from an exhaust hole. The parts of the flowmeter sensor part 74 other than the ultrasonic oscillators 81, 82 are made of PTFE.

86 is a flowmeter amplifier arranged inside the casing 89 of the electrical component module 88. The flowmeter amplifier 86 is provided with a processor finding the flow rate of the fluid flowing through the channel from the period of generation (frequency) of the Karman vortex and calculating the flow rate of the fluid. The processor has a transmission circuit outputting ultrasonic vibration of a certain period to the transmitting side ultrasonic oscillator 81, a reception circuit receiving ultrasonic vibration from the receiving side ultrasonic oscillator 82, a comparison circuit comparing the phases of the ultrasonic vibration, and a processing circuit cumulatively adding the Karman vortex detection signals output from the comparison circuit to calculate the flow rate. Further, in the casing 89, the connectors 90, 91 connected to wires extending from the flowmeter amplifier 86 are fastened so that the connection parts project out from the outside surface of the casing 89.

The valve module 75 and the electrical component module 88 are configured separately as two parts by detachably connecting the connectors of the cables 92, 93 to the connectors 84, 85, 90, 91 of the modules 75, 88. The rest of the configuration of the second embodiment is similar to that of the first embodiment, so the explanation will be omitted.

Next, the operation of the fluid control system of the second embodiment of the present invention will be explained.

The fluid flowing into the valve module 75 flows into the first flowmeter sensor part 74. The fluid flowing into the flowmeter sensor part 74 is measured for flow rate in the straight channel 80. Ultrasonic vibration is propagated through the fluid flowing inside the straight channel 80 from the ultrasonic oscillator 81 toward the ultrasonic oscillator 82. The Karman vortex generated downstream of the vortex generator 78 is generated at a period proportional to the flow rate of the fluid. Karman vortexes differing in vortex direction are alternately generated, so the ultrasonic vibration accelerates or decelerates in the direction of advance when passing through the Karman vortex depending on the vortex direction of the Karman vortex. For this reason, the ultrasonic vibration received by the ultrasonic oscillator 82 fluctuates in frequency (period) depending on the Karman vortex. The ultrasonic vibration transmitted and received by the ultrasonic oscillators 81, 82 is converted to an electrical signal which is output to the processor of the flowmeter amplifier 86. The processor of the flowmeter amplifier 86 calculates the flow rate of the fluid flowing through the straight channel 80 based on the frequency of the Karman vortex obtained from the phase difference between the ultrasonic vibration output from the transmitting side ultrasonic oscillator 81 and the ultrasonic vibration output from the receiving side ultrasonic oscillator 82. The flow rate calculated at the flowmeter amplifier 86 is converted to an electrical signal which is output to the controller 87. The operation of the other parts of the second embodiment is similar to that of the first embodiment, so an explanation will be omitted.

Further, the action when corrosive gas permeates inside the valve module when the fluid used in the second embodiment is a corrosive fluid and the procedure for installation of the fluid control system of the second embodiment inside the semiconductor production system are similar to those of the first embodiment, so explanations will be omitted. The ultrasonic wave type vortex flowmeter comprised of this flowmeter sensor part 74 and flowmeter amplifier 86 generates a larger Karman vortex the larger the flow rate, so can accurately measure the flow rate even when a large flow rate and exhibits a superior effect in fluid control of a large flow rate.

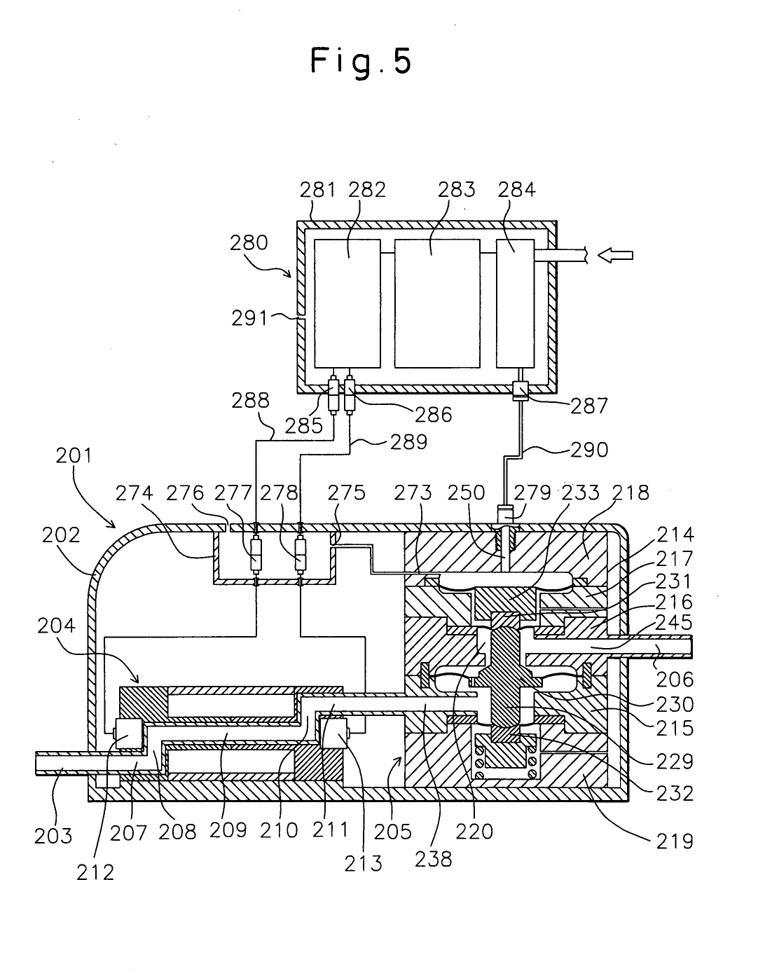

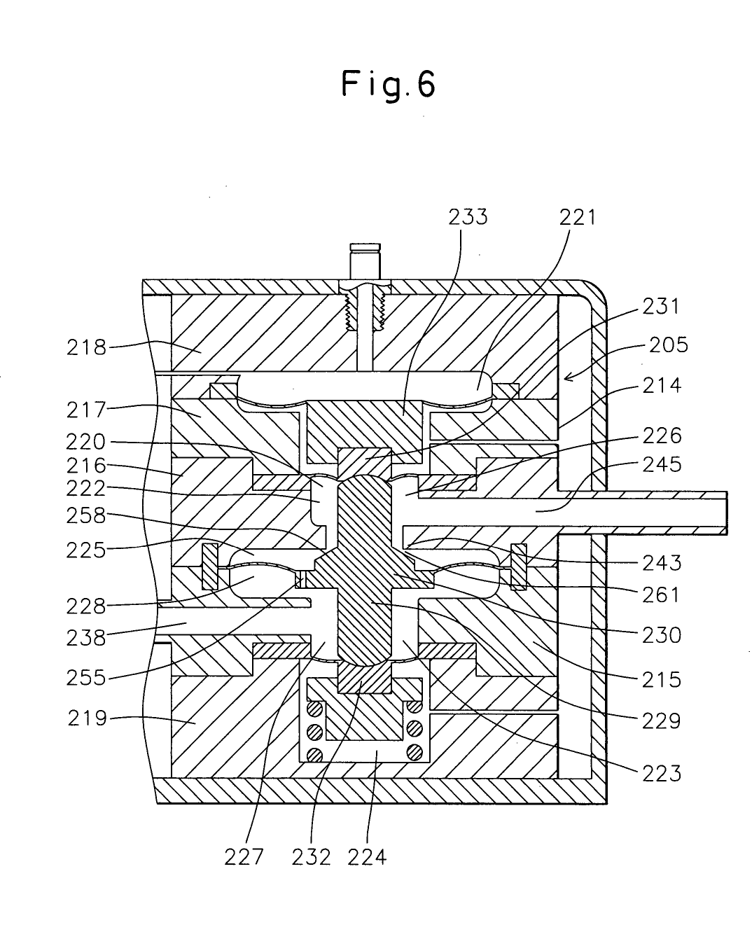

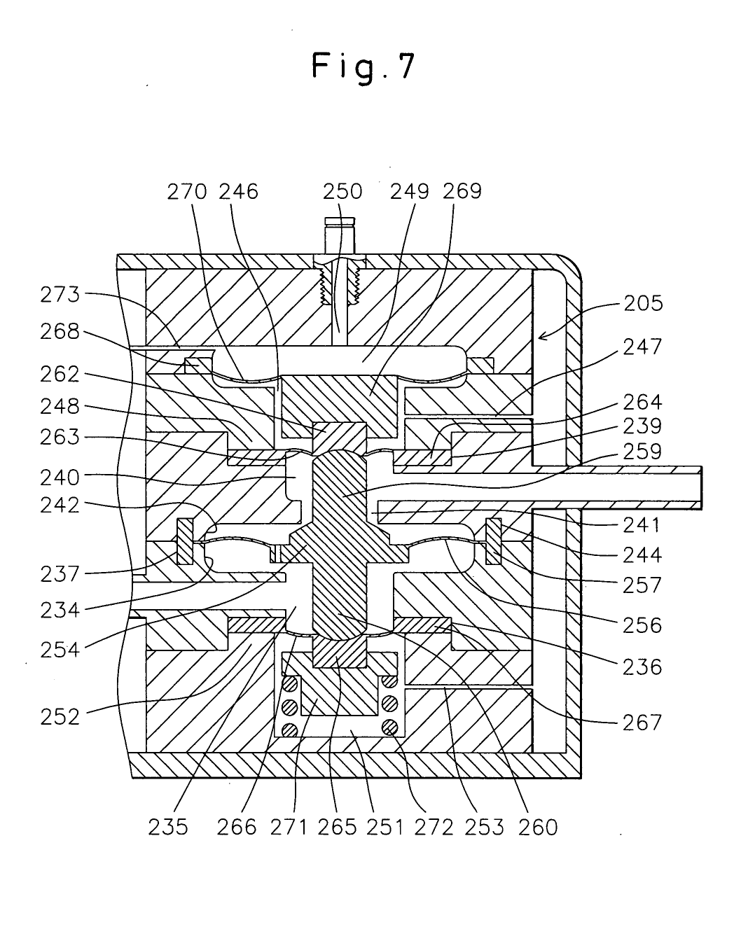

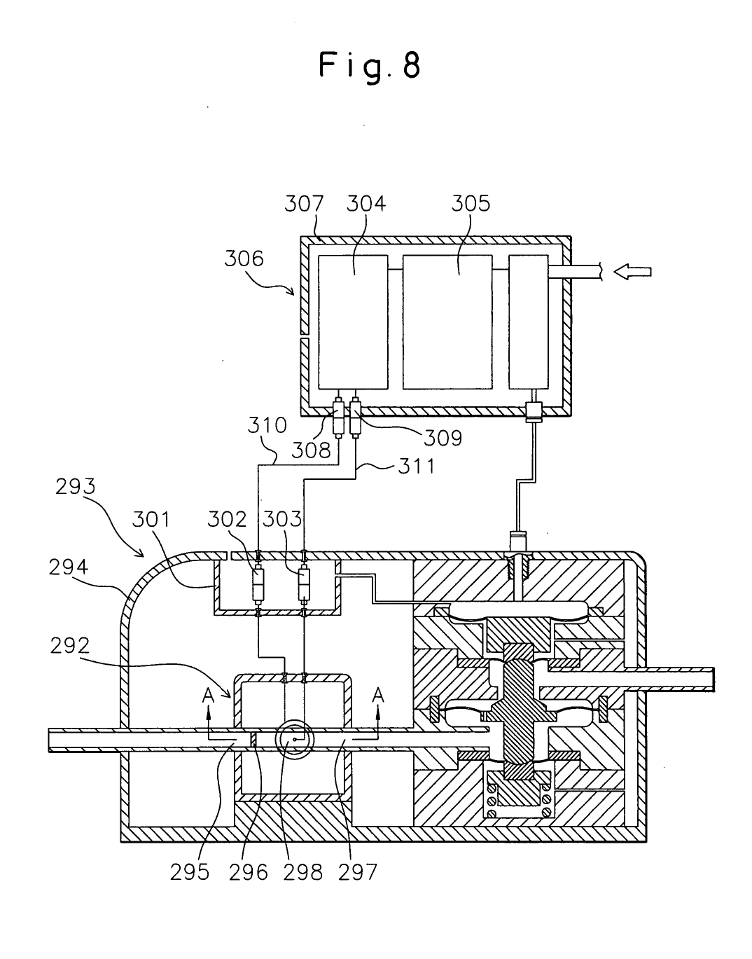

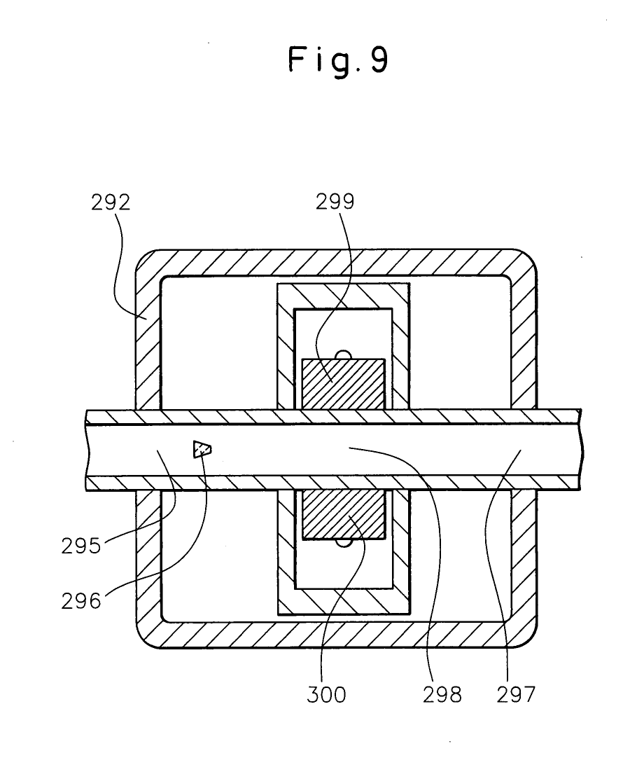

Below, the third and fourth embodiments of the present invention will be explained with reference to FIG. 5 to FIG. 9, but the present invention is not limited to the present embodiments of course. FIG. 5 is a longitudinal cross-sectional view of a fluid control system showing a third embodiment of the present invention. FIG. 6 is an enlarged view of principal parts of a constant flow valve of FIG. 5. FIG. 7 is a view the same as FIG. 6 comprised of FIG. 6 plus further illustration. FIG. 8 is a longitudinal cross-sectional view of a fluid control system showing a fourth embodiment of the present invention. FIG. 9 is a cross-sectional view along the line A-A of FIG. 8.

Below, a fluid control system of the third embodiment of the present invention will be explained based on FIG. 5 to FIG. 7.

201 is a valve module. The valve module 201 is formed from a casing 202, fluid inlet 203, flowmeter sensor part 204, constant flow valve 205, and fluid outlet 206. These are configured as explained above.

202 is a PVDF casing. In the casing 202, the flowmeter sensor part 204 and constant flow valve 205 are fastened by bolts and nuts (not shown) to the bottom of the casing 202. The fluid inlet 203, flowmeter sensor part 204, constant flow valve 205, and fluid outlet 206 are arranged in the state successively connected in that order. Further, the casing 202 is provided with a later explained connector box 274. The connector box 274 is formed so that inert gas or air is supplied from an intake hole 275 and exhausted from an exhaust hole 276. Note that the flowmeter sensor part 204 and the constant flow valve 205 may also be reversed in order.

203 is a PTFE fluid inlet. The fluid inlet 203 is communicated with the inlet channel 207 of the later explained flowmeter sensor part 204.

204 is a flowmeter sensor part measuring the flow rate of the fluid. The flowmeter sensor part 204 has an inlet channel 207 communicating with a fluid inlet 203, a first rising channel 208 vertically provided from the inlet channel 207, a straight channel 209 communicating with the first rising channel 208 and provided approximately parallel to an axis of the inlet channel 207, a second rising channel 210 vertically provided from the straight channel 209, and an outlet channel 211 communicating with the second rising channel 210 and provided approximately parallel to the axis of the inlet channel 207, the ultrasonic oscillators 212, 213 arranged facing each other at positions where side walls of the first and second rising channels 208, 210 intersect the axis of the straight channel 209. The ultrasonic oscillators 212, 213 are covered by a fluororesin, while the wires extending from the oscillators 212, 213 are connected to connectors 277, 278 in the later explained connector box 274. Note that the parts of the flowmeter sensor part 204 other than the ultrasonic oscillators 212, 213 are made of PFA.

205 is a constant flow valve controlling the flow rate in accordance with the working pressure. The constant flow valve 205 is formed by the main body 214, valve member 229, first diaphragm part 230, second diaphragm part 231, third diaphragm part 232, and fourth diaphragm part 233.

The main body part 214 has a chamber 220 divided inside it into the later explained first pressurizing chamber 221, second valve chamber 222, first valve chamber 223, and second pressurizing chamber 224, an inlet channel 238 for flow of fluid from the outside to the chamber 220, and an outlet channel 245 for flow from the chamber 220 to the outside. It is divided from the above into the main body D218, the main body C217, the main body B216, the main body A215, and the main body E219 and is configured by assembling these together.

215 is a PTFE main body A positioned at the inside of the main body part 214. It is provided with a flat circular shaped step difference 234 at its top and an opening 235 with a diameter smaller than that of the step difference 234 and forming the bottom first valve chamber 227 at the center of the step difference 234. Further, below the opening 235, a flat circular shaped bottom step difference 236 is provided continuously with a diameter larger than the diameter of the opening 235. The top surface of the main body A215, that is, the periphery of the step difference 234, is provided with a ring-shaped recessed groove 237. Further, the side surface is provided with an inlet channel 238 communicating with the opening 235 of the main body A215. The inlet channel 238 is communicated with the outlet channel 211 of the flowmeter sensor part 204.

216 is a PTFE main body B fastened by engagement with the top surface of the main body A215. It is provided with a flat circular shaped step difference 239 at its top and is provided with an opening 240 forming a top second valve chamber 226 of a smaller diameter than the step difference 239 at the center of the step difference 239. Further, below the opening 240, an opening 241 of a smaller diameter than the diameter of the opening 240 and the flat circular shaped bottom step difference 242 of a diameter the same as the step difference 234 of the main body A215 are provided successively. The bottom end periphery of the opening 241 forms a valve seat 243. At the bottom surface of the main body B216, that is, the periphery of the bottom step difference 242, a ring-shaped recessed groove 244 is provided at a position facing the ring-shaped recessed groove 237 of the main body A215. Further, an outlet channel 245 communicating with the opening 240 is provided from the side surface of the main body B216 positioned at the opposite side as the inlet channel 238 of the main body A215. The outlet channel 245 is communicated with the later explained fluid outlet 206.

217 is a PTFE main body C fastened by engagement with the top of the main body B216. It is provided at its center with a flat circular shaped diaphragm chamber 246 passing through the main body C217 from its top to bottom end faces and enlarged in diameter at the top and a breathing hole 247 communicating the diaphragm chamber 246 with the outside and at its bottom end face with a ring-shaped projection 248 engaged with the step difference 239 of the main body B216 centered about diaphragm chamber 246.

218 is a PTFE main body D positioned at the top of the main body C217. It is provided at its bottom with a gas chamber 249 and at its center with a feed hole 250 provided passing through the top surface for introducing inert gas or air from the outside to the gas chamber 249. Further, it is provided with a fine exhaust hole 273 provided passing through its side surface.

219 is a PVDF main body E fastened engaged with the bottom of the main body A215. It is provided at its center part with an opening 251 opening to the top surface and forming a second pressurizing chamber 224 and is provided at the periphery of the top surface of the opening 251 with a ring-shaped projection 252 fastened by engagement with the bottom step difference 236 of the main body A215. Further, the side surface of the main body E219 is provided with a small diameter breathing hole 253 communicating from there to the opening 251.

The five main body A215, main body B216, main body C217, main body D218, and main body E219 forming the main body part 214 explained above is fastened by being held between bolts and nuts (not shown).

229 is a PTFE valve member. It has a first diaphragm part 230 having a thick part 254 provided at the center in a flange shape, a communicating hole 255 provided passing through the thick part 254, a circular shaped thin film 256 provided extending from the outer periphery of the thick part 254 in the diametrical direction, and a ring-shaped rib 257 provided projecting vertically from the outer periphery of the thin film 256, a reverse vase-shaped valve element 258 provided at the top center of the first diaphragm part 230, a top rod 259 provided projecting upward from the top of the valve element 258 and with a top end formed into an approximately semispherical shape, and a bottom rod 260 provided projecting downward from the center part of the bottom end face of the thick part 254 and with a bottom end formed into an approximately semispherical shape—all formed integrally. The ring-shaped rib 257 provided at the outside periphery of the first diaphragm part 230 is engaged with the two ring-shaped recessed grooves 237, 244 provided in the main body A215 and the main body B216 and is fastened held between the main body A215 and the main body B216. Further, the space formed between the inclined face of the valve element 258 and the periphery of the bottom end face of the opening 241 of the main body B216 forms a fluid controller 261.

231 is a PTFE second diaphragm part. It has a columnar thick part 262 at the center and a circular shaped thin film 263 provided extending from the bottom end face of the thick part 262 in the diametrical direction and a ring-shaped seal 264 provided at the outer periphery of the thin film 263 and is formed integrally. Further, the ring-shaped seal 264 of the periphery of the thin film 263 is fastened by being held between the top step difference 239 of the main body B216 and the ring-shaped projection 248 of the main body C217.

Note that the pressure receiving area of the second diaphragm part 231 must be provided smaller than that of the first diaphragm part 230.

232 is a PTFE third diaphragm part. It is shaped the same as the second diaphragm part 231 but is arranged turned upside down. The top end face of the thick part 265 contacts the bottom rod 260 of the valve member 229. Further, the ring-shaped seal 267 of the periphery of the thin film 266 is fastened held between the bottom step difference 236 of the main body A215 and the ring-shaped projection 252 of the main body E219.

Note that the pressure receiving area of the third diaphragm part 232 has to be provided smaller than that of the first diaphragm part 230 in the same way as above.

233 is a fourth diaphragm part. It has a cylindrical rib 268 of approximately the same outside diameter as the diaphragm chamber 246 of the main body C217 at its periphery and a columnar part 269 and film part 270 provided connecting the inside periphery of the bottom end face of the cylindrical rib 268 and outside periphery of the top end face of the columnar part 269 at its center. The cylindrical rib 268 is fastened by engagement with the diaphragm chamber 246 of the main body C217 and fastened held between the main body D218 and the main body C217. The columnar part 269 can move vertically in the diaphragm chamber 246. Further, the bottom of the columnar part 269 has the thick part 262 of the second diaphragm part 231 engaged with it.

271 and 272 are a PVDF spring receiver and SUS spring coated with a fluororesin arranged at the opening 251 of the main body E219. The two press the third diaphragm part 232 in the inward direction (in the figure, upward).

Due to the above explained configuration, the chamber 220 formed inside the main body part is divided into a first pressurizing chamber 221 formed from the fourth diaphragm part 233 and the gas chamber 249 of the main body D218, a second valve chamber 222 comprised of both of a bottom second valve chamber 225 formed between the first diaphragm part 230 and the bottom step difference 242 of the main body B216 and a top second valve chamber 226 formed from a second diaphragm part 231 and the opening 240 of the main body B216, a first valve chamber 223 formed by the bottom first valve chamber 227 formed by the third diaphragm part 232 and the opening 235 of the main body A215 and the top first valve chamber 228 formed by the first diaphragm part 230 and the step difference 234 of the main body A215, and a second pressurizing chamber 224 formed by the third diaphragm part 232 and the opening 251 of the main body E219.

206 is a PTFE fluid outlet.

274 is a PVDF connector box provided at the casing 202. The connector box 274 is provided with an intake hole 275 communicating with the inside of the casing 202 and an exhaust hole 276 communicating with the outside of the casing 202. The intake hole 275 is connected through a tube with the exhaust hole 273 of the constant flow valve 205. The connector box 274 is formed to be supplied with compressed inert gas or air from the intake hole 275 and to exhaust it from the exhaust hole 276. Inside the connector box 274 are arranged connectors 277, 278 connected with wires extending from the ultrasonic oscillators 212, 213. The connectors 277, 278 are detachably connected to the connectors of the cables 288, 289 connected with wires extending from the flowmeter amplifier 282 of the later explained electrical component module 280.

Further, in the casing 20, an air connector 279 connected to a pipe extending to the feed hole 250 of the pressure control valve 205 is fastened by the connection part projecting out from the outer surface of the casing 202.

280 is an electrical component module. The electrical component module 280 is formed from a casing 281, flowmeter amplifier 282, controller 283, and electro-pneumatic converter 284. These are configured as follows:

281 is a PVDF casing. Inside the casing 281, the flowmeter amplifier 282, controller 283, and electro-pneumatic converter 284 are set. Further, the casing 281 is supplied with inert gas or air from the outside to the electro-pneumatic converter 284. The casing 281 is provided with an exhaust port 291, and the casing 281 is supplied with compressed air from the electro-pneumatic converter 284 to the inside of the casing 281. The casing 281 is formed so that compressed air supplied from the electro-pneumatic converter 284 to the inside of the casing 281 is exhausted from the exhaust port 291.

282 is a flowmeter amplifier. The flowmeter amplifier 282 has a processor calculating the flow rate from the signal output from the flowmeter sensor part 204. The processor is provided with a transmission circuit outputting ultrasonic vibration of a certain period to the transmitting side ultrasonic oscillator 212, a reception circuit receiving the ultrasonic vibration from the receiving side ultrasonic oscillator 213, a comparison circuit comparing the propagation times of the ultrasonic vibrations, and a processing circuit calculating the flow rate from the difference of propagation times output from the comparison circuit.

283 is a controller. The controller 283 has a control circuit performing feedback control so that the flow rate output from the flowmeter amplifier 282 becomes the set flow rate and controlling the working pressure of the later explained electro-pneumatic converter 284.

284 is an electro-pneumatic converter adjusting the working pressure of the inert gas or air. The electro-pneumatic converter 284 is comprised of a solenoid valve electrically driving the device so as to proportionally adjust the working pressure and adjusts the working pressure of the constant flow valve 205 in accordance with the control signal from the controller 283.

Further, the casing 281 has connectors 285, 286 connected to wires extending from the flowmeter amplifier 282 fastened so that the connection parts project out from the outer surface of the casing 281. Similarly, the air connector 287 connected to a pipe extending from the electro-pneumatic converter 284 is fastened so that the connection parts project out from the outer surface of the casing 281.

The valve module 201 and the electrical component module 280 are configured separately as two parts by detachably connecting the connectors of the cables 288, 289 to the connectors 277, 278, 285, 286 of the modules 201, 280 and detachably connecting the tube 290 to the air connectors 279, 287 of the modules 201, 280. Note that in the present invention, there were two cables, but these may also be bundled into one. In this case, the modules 201, 280 are also provided with one connector each.

Next, the operation of the fluid control system of the third embodiment of the present invention will be explained.

The fluid flowing in from the fluid inlet 203 of the valve module 201 first flows into the flowmeter sensor part 204.

The fluid flowing into the flowmeter sensor part 204 is measured for flow rate in the straight channel 209. Ultrasonic vibration is propagated from the ultrasonic oscillator 212 positioned at the upstream side in the flow of fluid toward the ultrasonic oscillator 213 positioned at the downstream side. The ultrasonic vibration received by the ultrasonic oscillator 213 is converted to an electrical signal which is output to the processor of the flowmeter amplifier 282. When the ultrasonic vibration is received propagated from the upstream side ultrasonic oscillator 212 to the downstream side ultrasonic oscillator 213, transmission and reception are instantaneously switched inside the processor and ultrasonic vibration is propagated from the ultrasonic oscillator 213 positioned at the downstream side toward the ultrasonic oscillator 212 positioned at the upstream side position. The ultrasonic vibration received by the ultrasonic oscillator 212 is converted to an electrical signal which is output to the processor of the flowmeter amplifier 282. At this time, the ultrasonic vibration is propagated against the flow of fluid in the straight channel 209, so compared to when the ultrasonic vibration is propagated from the upstream side to the downstream side, the speed of propagation of the ultrasonic vibration in the fluid is slowed and the propagation time becomes longer. The output electrical signals are measured for propagation time in the processor of the flowmeter amplifier 282, then the flow rate is calculated from the difference in propagation times. The flow rate calculated at the flowmeter amplifier 282 is converted to an electrical signal which is output to the controller 283.

Next, the fluid passing through the flowmeter sensor part 204 flows into the constant flow valve 205. The controller 283 outputs a signal to the electro-pneumatic converter 284 so as to make the difference between the flow rate measured in real time from any set flow rate zero. The electro-pneumatic converter 284 supplies a working pressure corresponding to this to the constant pressure valve 205 to drive it. The flow rate of the fluid from the constant flow valve 205 is controlled by the pressure control valve 205 so that the flow rate becomes a constant value at the set flow rate, that is, the difference between the set flow rate and the measured flow rate converges to zero.

Here, the operation of the constant flow valve 5 with respect to the working pressure supplied from the electro-pneumatic converter 284 will be explained. The fluid flowing from the inlet channel 238 of the main body A215 into the first valve chamber 223 is reduced in pressure by passing through the communicating hole 255 of the valve member 229 and flows into the bottom second valve chamber 225. Further, the fluid flows from the bottom second valve chamber 225 through the fluid controller 261 into the top second valve chamber 226 during which it is again reduced in pressure by the pressure loss at the fluid controller 261 and then flows out from the outlet channel 245. Here, the diameter of the communicating hole 255 is set sufficiently smaller than the diameter, so the flow rate through the valve is determined by the difference in pressures before and after the communicating hole 255.

At this time, viewing the forces received by the diaphragm parts 230, 231, 232 from the fluid, the first diaphragm part 230 receives the upward direction force due to the difference in fluid pressures inside the first valve chamber 223 and the bottom second valve chamber 225, the second diaphragm part 231 receives the upward direction force due to the fluid pressure of the top second valve chamber 226, and the third diaphragm part 232 receives the downward direction force due to the fluid pressure inside the first valve chamber 223. Here, the pressure receiving area of the first diaphragm part 230 is provided sufficiently larger than the pressure receiving areas of the second diaphragm part 231 and the third diaphragm part 232, so the forces acting on the second and third diaphragm parts 231, 232 can be almost completely ignored compared with the force acting on the first diaphragm part 230. Therefore, the force received by the valve member 229 from the fluid becomes an upward direction force due to the difference in fluid pressures in the first valve chamber 223 and the bottom second valve chamber 225.

Further, the valve member 229 is biased downward by the pressurizing means of the first pressurizing chamber 221 and is simultaneously biased upward by the pressurizing means of the second pressurizing chamber 224. If adjusting the force of the pressurizing means of the first pressurizing chamber 221 to be larger than the force of the pressurizing means of the second pressurizing chamber 224, the composite force which the valve member 229 receives from the pressurizing means becomes a downward direction force. Here, the pressurizing means of the first pressurizing chamber 221 means the working pressure supplied from the electro-pneumatic converter 284. The pressurizing means of the second pressurizing chamber 224 is the resiliency of the spring 272.

Therefore, the valve member 229 stabilizes at the position where the downward direction composite force of the pressurizing means and the upward direction force due to the difference in fluid pressures in the first valve chamber 223 and the bottom second valve chamber 225 balance. That is, the pressure of the bottom second valve chamber 225 is autonomously adjusted by the opening area of the fluid controller 261 so that the composite force by the pressurizing means and the force due to the difference in fluid pressures balance. Therefore, the difference in fluid pressures inside the first valve chamber 223 and the bottom second valve chamber 225 become constant and the differential pressure before and after the communicating hole 255 is kept constant, so the flow rate through the valve is maintained constantly constant.

Here, the constant flow valve 205 operates so that the composite force of the pressurizing means acting on the valve member 229 and the force due to the pressure difference between the first valve chamber 223 and the bottom second valve chamber 225 balance, so if adjusting the composite force of the pressurizing means acting on the valve member 229, the difference in fluid pressures between the first valve chamber 223 and the bottom second valve chamber 225 becomes a corresponding value. That is, by adjusting the downward direction force due to the pressurizing means of the first pressurizing chamber, that is, the working pressure supplied from the electro-pneumatic converter 284, the differential pressure before and after the communicating hole 255 can be changed, so the flow rate can be set to any flow rate without disassembling the valve.

Further, if adjusting the force of the pressurizing means of the first pressurizing chamber 221 to become smaller than the force of the pressurizing means of the second pressurizing chamber 224, the composite force acting on the valve member 229 becomes only the upward direction, the valve element 258 of the valve member 229 is pushed against the valve seat 243 of the opening 241 of the main body B216, and the fluid can be cut off. That is, unless adjusting the electro-pneumatic converter 284 to apply working pressure, the constant flow valve becomes closed.

Due to the above operation, the fluid flowing into the fluid inlet 203 of the valve module 201 is controlled to become constant at the set flow rate and flows out from the fluid outlet 206. The ultrasonic wave flowmeter comprised of this flowmeter sensor part 204 and flowmeter amplifier 282 measures the flow rate from the difference of the propagation times in the direction of the flow of fluid, so can accurately measure the flow rate even if a fine flow rate. Further, the constant flow valve 205 exhibits superior effects in fluid control of a fine flow rate since the above configuration enables a compact structure and stable fluid pressure control. Further, even if the upstream side pressure or downstream side pressure of the fluid flowing into the fluid inlet 203 of the valve module 201 fluctuates, the constant flow valve 205 operates so that the flow rate is autonomously kept constant, so even if pulsation or other instantaneous pressure fluctuations of the pump occur, stable control of the flow rate is possible. Further, since the constant flow valve 205 can be used as a shutoff valve by adjusting the working pressure, it is not necessary to connect a separate fluid cutoff valve. Further, the parts of the valve module 201 are provided assembled together in the casing 2, so the pressure loss of the connection parts is kept to the lowest extent and flow measurement with smaller error becomes possible.

Next, the action when corrosive gas permeates into the valve module when the fluid of the fluid control system of the third embodiment of the present invention is a corrosive fluid will be explained.

The fluid control system of the present invention is configured separated into the valve module 201 and the electrical component module 280. The parts in the valve module 201 are made of a fluororesin resistant to corrosion, so there is no concern over corrosion. The ultrasonic oscillators 212, 213 are also covered by a fluororesin, so corrosion can be prevented. The spring 272 is coated by a fluororesin, so corrosion can be prevented. The parts in the valve module 201 which may be corroded are the connectors 277, 278, but the inside of the connector box 274 where the connectors 277, 278 are arranged has the compressed air exhausted from the exhaust hole 273 and supplied from the intake hole 275 constantly exhausted from the exhaust hole 276 to outside the casing 202, so the permeated corrosive gas is exhausted riding the flow of air and does not easily build up in the connector box 274, and corrosion can be prevented.

On the other hand, there are parts which would affect the flow measurement or fluid control when the electrical component module 280 corrodes, but these are configured separated from the valve module 201, so by arrangement at a position not affected by the corrosive gas, corrosion of the parts in the electrical component module 280 can be prevented. Further, the inside of the casing 281 of the electrical component module 280 is constantly having compressed air supplied from the electro-pneumatic converter 284 to the inside of the casing 281 exhausted from the exhaust port 291, so even if the electrical component module 280 is installed at a position affected by the corrosive gas, the permeated corrosive gas is exhausted riding the flow of the air and does not easily build up inside casing 281, so corrosion of the parts of the electrical component module 280 can be prevented.

Next, the procedure for installation of fluid control system of the third embodiment of the present invention inside a semiconductor production system will be explained.

First, the valve module 201 is arranged at a predetermined position in a pipeline in the semiconductor production system, the fluid inlet 203 and fluid outlet 206 are connected to pipes of the pipeline, and the valve module 201 is fastened in the semiconductor production system. Further, the electrical component module 280 is set at a predetermined position separated from the pipeline in the semiconductor production system. Next, first connectors of the cables 288, 289 are inserted into the connector box 274 of the valve module 201 and connected to the connectors 277, 278, then other connectors of the cables 288, 289 are connected to the connectors 285, 286 of the electrical component module 280. Next, one end of the tube 290 is inserted into the air connector 279 of the valve module 201, then the other end of the tube 290 is inserted into the air connector 287 of the electrical component module 280. By the above procedure, installation in the semiconductor production system becomes extremely easy, the connection of wires and air pipes becomes just connection of connectors, and the work can be performed easily in a short time.

Further, according to the configuration of the present invention, replacement work becomes easy even if part of the fluid control system breaks. Further, when installing a plurality of fluid control systems, the electrical component modules are installed together in the control box, so central management of the fluid control systems of the present invention becomes possible.

Below, a fluid control system of a fourth embodiment of the present invention will be explained based on FIG. 8 and FIG. 9.

292 is a flowmeter sensor part arranged inside the casing 294 of the valve module 293. The flowmeter sensor part 292 has an inlet channel 295, a vortex generator 296 generating a Karman vortex provided vertically inside the inlet channel 295, and an outlet channel 297 provided in a straight channel 298. The ultrasonic oscillators 299, 300 are arranged facing each other at positions at the side walls of the straight channel 298 at the downstream side of the vortex generator 296 perpendicularly intersecting the channel axial direction. The ultrasonic oscillators 299, 300 are covered by a fluororesin. The wires extending from the oscillators 299, 300 are connected to connectors 302, 303 inside the connector box 301. In the same way as the third embodiment, the connector box 301 is formed so that compressed inert gas or air is supplied from its own intake hole and is exhausted from an exhaust hole. The parts of the flowmeter sensor part 292 other than the ultrasonic oscillators 299, 300 are made of PTFE.

304 is a flowmeter amplifier arranged inside the casing 307 of the electrical component module 306. The flowmeter amplifier 304 is provided with a processor finding the flow rate of the fluid flowing through the channel from the period of generation (frequency) of the Karman vortex and calculating the flow rate of the fluid. The processor has a transmission circuit outputting ultrasonic vibration of a certain period to the transmitting side ultrasonic oscillator 299, a reception circuit receiving ultrasonic vibration from the receiving side ultrasonic oscillator 300, a comparison circuit comparing the phases of the ultrasonic vibration, and a processing circuit cumulatively adding the Karman vortex detection signals output from the comparison circuit to calculate the flow rate. Further, in the casing 307, the connectors 308, 309 connected to wires extending from the flowmeter amplifier 304 are fastened so that the connection parts project out from the outside surface of the casing 307.

The valve module 293 and the electrical component module 306 are configured separated from each other by the connectors of the cables 310, 311 being detachably connected to the connectors 302, 303, 308, 309 of the modules 293, 306. The rest of the configuration of the fourth embodiment is similar to that of the third embodiment, so the explanation will be omitted.

Next, the operation of the fluid control system of the fourth embodiment of the present invention will be explained.

The fluid flowing into the valve module 293 flows into the first flowmeter sensor part 292. The fluid flowing into the flowmeter sensor part 292 is measured for flow rate in the straight channel 298. Ultrasonic vibration is propagated through the fluid flowing inside the straight channel 298 from the ultrasonic oscillator 299 toward the ultrasonic oscillator 300. The Karman vortex generated downstream of the vortex generator 296 is generated at a period proportional to the flow rate of the fluid. Karman vortexes differing in vortex direction are alternately generated, so the ultrasonic vibration accelerates or decelerates in the direction of advance when passing through the Karman vortex depending on the vortex direction of the Karman vortex. For this reason, the ultrasonic vibration received by the ultrasonic oscillator 300 fluctuates in frequency (period) depending on the Karman vortex. The ultrasonic vibration transmitted and received by the ultrasonic oscillators 299, 300 is converted to an electrical signal which is output to the processor of the flowmeter amplifier 304. The processor of the flowmeter amplifier 304 calculates the flow rate of the fluid flowing through the straight channel 298 based on the frequency of the Karman vortex obtained from the phase difference between the ultrasonic vibration output from the transmitting side ultrasonic oscillator 299 and the ultrasonic vibration output from the receiving side ultrasonic oscillator 300. The flow rate calculated at the flowmeter amplifier 304 is converted to an electrical signal which is output to the controller 305. The operation of the other parts of the fourth embodiment is similar to that of the third embodiment, so an explanation will be omitted.

Further, the action when corrosive gas permeates inside the valve module when the fluid used in the fourth embodiment is a corrosive fluid and the procedure for installation of the fluid control system of the fourth embodiment inside the semiconductor production system are similar to those of the third embodiment, so explanations will be omitted. The ultrasonic wave type vortex flowmeter comprised of this flowmeter sensor part 292 and flowmeter amplifier 304 generates a larger Karman vortex the larger the flow rate, so can accurately measure the flow rate even when a large flow rate and exhibits a superior effect in fluid control of a large flow rate.

1-17. (canceled)

18. A fluid control system provided with a flowmeter sensor part having an ultrasonic oscillator generating an ultrasonic wave in a fluid and an ultrasonic oscillator receiving the ultrasonic wave generated from said ultrasonic oscillator and outputting a signal to a flowmeter amplifier and a control valve controlling the state of flow of fluid to a predetermined state by a working pressure, wherein
at least the flowmeter sensor part and the control valve are connected inside a single first casing having a fluid inlet and a fluid outlet.

19. A fluid control system as set forth in claim 18, wherein said control valve is a pressure control valve controlling the pressure of the flow of fluid to a predetermined pressure by its working pressure.

20. A fluid control system as set forth in claim 19, wherein the fluid control system is provided with
a valve module comprised of said flowmeter sensor part and said pressure control valve set in a single first casing and
an electrical component module comprised of a flowmeter amplifier calculating a flow rate by the signal of the flowmeter sensor part, an electro-pneumatic converter adjusting the working pressure of the pressure control valve, and a controller for adjusting the working pressure and performing feedback control based on the value of the flow rate calculated by the flowmeter amplifier set in a single second casing,
said valve module and said electrical component module being comprised of separate members.

21. A fluid control system as set forth in claim 20, wherein the second casing of said electrical component module is formed with an exhaust port provided so as to exhaust a gas filled in said second casing.

22. A fluid control system as set forth in claim 21, wherein said flowmeter sensor part is a flowmeter sensor part provided successively with an inlet channel communicating with the fluid inlet, a first rising channel vertically provided from the inlet channel, a straight channel communicating with the first rising channel and provided approximately parallel to an axis of the inlet channel, a second rising channel vertically provided from the straight channel, and an outlet channel communicating with the second rising channel, provided approximately parallel to the axis of the inlet channel, and communicating with the inlet channel of the pressure control valve, the ultrasonic oscillators arranged facing each other at positions where side walls of the first and second rising channels intersect the axis of the straight channel; and
said flowmeter amplifier is a flowmeter amplifier to which the ultrasonic oscillators are connected through cables; and
said flowmeter sensor part and said flowmeter amplifier form an ultrasonic wave flowmeter which alternately switches between transmission and reception of the ultrasonic oscillators and measures the difference in propagation times of ultrasonic waves between the ultrasonic oscillators so as to calculate the flow rate of fluid running through the straight channel.

23. A fluid control system as set forth in claim 22, wherein said pressure control valve is provided with
a main body having a second cavity provided opened at a bottom center to a bottom, an inlet channel communicating with the second cavity, a first cavity provided opened at a top surface to the top and having a diameter larger than a diameter of the second cavity, an outlet channel communicating with the first cavity, and a communicating hole connecting the first cavity and second cavity and having a diameter smaller than the diameter of the first cavity, the top surface of the second cavity being made a valve seat;
a bonnet having a cylindrical cavity inside it and provided with a step difference at the inside periphery of the bottom end;
a feed hole provided on a side surface or top surface of the bonnet and feeding a pressurized gas into said cylindrical cavity;
a spring receiver inserted into the step difference of the bonnet and having a through hole at the center part;
a piston having a first engagement part having a diameter smaller than the through hole of the spring receiver at the bottom end, provided with a flange at the top, and inserted into the cavity of the bonnet to enable vertical movement;
a spring held and supported between a bottom end face of the flange of the piston and a top end face of the spring receiver;
a first valve mechanism having a first diaphragm with a periphery fastened held between the main body and spring receiver and with a thick center part forming a first valve chamber in a form capping the first cavity of the main body, a second engagement part fastened connected to the first engagement part of the piston and passing through the through hole of the spring receiver at the center of the top surface, and a third engagement part provided passing through a communicating hole of the main body at the center of the bottom surface;
a second valve mechanism having a valve element positioned inside the second cavity of the main body and provided with a diameter larger than the communicating hole of the main body, a fourth engagement part provided projecting out at the top end face of the valve element and fastened connected to the third engagement part of the first valve mechanism, and a rod provided projecting out from the bottom end face of the valve element and a second diaphragm provided extending from the bottom end face of the rod in the diametrical direction; and
a base plate positioned below the main body, having a projecting part holding and fastening the periphery of the second diaphragm of the second valve mechanism with the main body at the top center, provided with a cut recess at the top end of the projecting part, and provided with a breathing hole communicating with the cut recess;
the opening area of the fluid controller formed by the valve element of the second valve mechanism and the valve seat of the main body changing along with vertical movement of the piston.

24. A fluid control system as set forth in claim 20, wherein said pressure control valve is provided with
a main body having a second cavity provided opened at a bottom center to a bottom, an inlet channel communicating with the second cavity, a first cavity provided opened at a top surface to the top and having a diameter larger than a diameter of the second cavity, an outlet channel communicating with the first cavity, and a communicating hole connecting the first cavity and second cavity and having a diameter smaller than the diameter of the first cavity, the top surface of the second cavity being made a valve seat;
a bonnet having a cylindrical cavity inside it and provided with a step difference at the inside periphery of the bottom end;
a feed hole provided on a side surface or top surface of the bonnet and feeding a pressurized gas into said cylindrical cavity;
a spring receiver inserted into the step difference of the bonnet and having a through hole at the center part;
a piston having a first engagement part having a smaller diameter than the through hole of the spring receiver at the bottom end, provided with a flange at the top, and inserted into the cavity of the bonnet to enable vertical movement;
a spring held and supported between a bottom end face of the flange of the piston and a top end face of the spring receiver;
a first valve mechanism having a first diaphragm with a periphery fastened held between the main body and spring receiver and with a thick center part forming a first valve chamber in a form capping the first cavity of the main body, a second engagement part fastened connected to the first engagement part of the piston and passing through the through hole of the spring receiver at the center of the top surface, and a third engagement part provided passing through a communicating hole of the main body at the center of the bottom surface;
a second valve mechanism having a valve element positioned inside the second cavity of the main body and provided with a larger diameter than the communicating hole of the main body, a fourth engagement part provided projecting out at the top end face of the valve element and fastened connected to the third engagement part of the first valve mechanism, and a rod provided projecting out from the bottom end face of the valve element and a second diaphragm provided extending from the bottom end face of the rod in the diametrical direction; and
a base plate positioned below the main body, having a projecting part holding and fastening the periphery of the second diaphragm of the second valve mechanism with the main body at the top center, provided with a cut recess at the top end of the projecting part, and provided with a breathing hole communicating with the cut recess;
the opening area of the fluid controller formed by the valve element of the second valve mechanism and the valve seat of the main body changing along with vertical movement of the piston,
cables connecting said flowmeter sensor part and flowmeter amplifier are provided detachably through connectors to the flowmeter sensor part and/or flowmeter amplifier,
a side surface or top surface of the bonnet of said pressure control valve is provided with an exhaust hole for exhausting a gas from the inside of said cylindrical cavity,
said exhaust hole is communicated with an intake hole of a connector box provided at said first casing, and the connector box is provided with an exhaust hole communicated with the outside of the first casing.

25. A fluid control system as set forth in claim 24, wherein said flowmeter sensor part is a flowmeter sensor part provided successively with an inlet channel communicating with the fluid inlet, a first rising channel vertically provided from the inlet channel, a straight channel communicating with the first rising channel and provided approximately parallel to an axis of the inlet channel, a second rising channel vertically provided from the straight channel, and an outlet channel communicating with the second rising channel, provided approximately parallel to the axis of the inlet channel, and communicating with the inlet channel of the pressure control valve, the ultrasonic oscillators arranged facing each other at positions where side walls of the first and second rising channels intersect the axis of the straight channel; and
said flowmeter amplifier is a flowmeter amplifier to which the ultrasonic oscillators are connected through cables; and
said flowmeter sensor part and said flowmeter amplifier form an ultrasonic wave flowmeter which alternately switches between transmission and reception of the ultrasonic oscillators and measures the difference in propagation times of ultrasonic waves between the ultrasonic oscillators so as to calculate the flow rate of fluid running through the straight channel.

26. A fluid control system as set forth in claim 18, wherein said control valve is a constant flow valve (205) controlling the flow rate of the flow of fluid to a predetermined flow rate by its working pressure.

27. A fluid control system as set forth in claim 26, wherein the fluid control system is provided with:
a valve module comprised of said flowmeter sensor part and said constant flow valve arranged at a single first casing and
an electrical component module comprised of a flowmeter amplifier for calculating the flow rate by the signal of the flowmeter sensor part, an electro-pneumatic converter for adjusting the working pressure of the constant flow valve, and a controller for adjusting the working pressure based on the value of the flow rate calculated by the flowmeter amplifier for feedback control arranged in a single second casing,
said valve module and said electrical component module being comprised of separate members.

28. A fluid control system as set forth in claim 27, wherein the second casing of said electrical component module is formed with an exhaust port provided for exhausting a gas filled in said second casing.

29. A fluid control system as set forth in claim 28, wherein said flowmeter sensor part is a flowmeter sensor part provided successively with an inlet channel communicating with the fluid inlet, a first rising channel vertically provided from the inlet channel, a straight channel communicating with the first rising channel and provided approximately parallel to the axis of the inlet channel, a second rising channel vertically provided from the straight channel, and an outlet channel communicating with the second rising channel, provided approximately parallel to the axis of the inlet channel, and communicating with the inlet channel of the constant flow valve, the ultrasonic oscillators being arranged facing each other at positions where side walls of the first and second rising channels intersect the axis of the straight channel; and
said flowmeter amplifier is a flowmeter amplifier to which the ultrasonic oscillators are connected through cables; and
said flowmeter sensor part and said flowmeter amplifier form an ultrasonic wave flowmeter which alternately switches between transmission and reception of the ultrasonic oscillators and measures the difference in propagation times of ultrasonic waves between the ultrasonic oscillators so as to calculate the flow rate of fluid running through the straight channel.

30. A fluid control system as set forth in claim 29, wherein said constant flow valve has a main body part formed from an inlet channel and outlet channel of the fluid and a chamber communicated with the inlet channel and outlet channel, a valve member having a valve element and first diaphragm part, and a second diaphragm part and a third diaphragm part positioned at the bottom and top of the valve member and having a smaller effective pressure receiving area than the first diaphragm part;
the valve member and diaphragm parts are attached inside the chamber so that the outer peripheries of the diaphragm parts are fastened at the main body part and the diaphragm parts divide the chamber into a first pressurizing chamber, a second valve chamber, a first valve chamber, and a second pressurizing chamber;
the first pressurizing chamber has a means for constantly applying a certain inwardly directed force to the second diaphragm part;
the first valve chamber is communicated with the inlet channel;
the second valve chamber has a valve seat corresponding to the valve element of the valve member, further is formed divided into a bottom second valve chamber positioned at the first diaphragm part side with respect to the valve seat and communicated with the first valve chamber by a communicating hole provided at the first diaphragm part and a top second valve chamber positioned at a second diaphragm part side and provided communicating with the outlet channel, and having a fluid controller changing in opening area between the valve element and the valve seat by vertical movement of the valve member and thereby controlled in fluid pressure of the bottom second valve chamber; and
the second pressurizing chamber has a means for constantly applying a certain inwardly directed force to the third diaphragm part.

31. A fluid control system as set forth in claim 27, wherein said constant flow valve has a main body part formed from an inlet channel and outlet channel of the fluid and a chamber communicated with the inlet channel and outlet channel, a valve member having a valve element and first diaphragm part, and a second diaphragm part and a third diaphragm part positioned at the bottom and top of the valve member and having a smaller effective pressure receiving area than the first diaphragm part;
the valve member and diaphragm parts are attached inside the chamber so that the outer peripheries of the diaphragm parts are fastened at the main body part and the diaphragm parts divide the chamber into a first pressurizing chamber, a second valve chamber, a first valve chamber, and a second pressurizing chamber;
the first pressurizing chamber has a means for constantly applying a certain inwardly directed force to the second diaphragm part;
the first valve chamber is communicated with the inlet channel;
the second valve chamber has a valve seat corresponding to the valve element of the valve member, further is formed divided into a bottom second valve chamber positioned at the first diaphragm part side with respect to the valve seat and communicated with the first valve chamber by a communicating hole provided at the first diaphragm part and a top second valve chamber positioned at a second diaphragm part side and provided communicating with the outlet channel, and having a fluid controller changing in opening area between the valve element and the valve seat by vertical movement of the valve member and thereby controlled in fluid pressure of the bottom second valve chamber; and
the second pressurizing chamber has a means for constantly applying a certain inwardly directed force to the third diaphragm part,
cables connecting said flowmeter sensor part and flowmeter amplifier are provided detachably through connectors to the flowmeter sensor part and/or flowmeter amplifier;
a side surface or top surface of the main body part of said constant flow valve is provided with a feed hole for feeding pressurized gas into said first pressurizing chamber and an exhaust hole exhausting the gas from the inside of said first pressurizing chamber; and
said exhaust hole is communicated with an intake hole of a connector box provided at said first casing, and the connector box is provided with an exhaust hole communicated with the outside of the first casing.

32. A fluid control system as set forth in claim 31, wherein said flowmeter sensor part is a flowmeter sensor part provided successively with an inlet channel communicating with the fluid inlet, a first rising channel vertically provided from the inlet channel, a straight channel communicating with the first rising channel and provided approximately parallel to the axis of the inlet channel, a second rising channel vertically provided from the straight channel, and an outlet channel communicating with the second rising channel, provided approximately parallel to the axis of the inlet channel, and communicating with the inlet channel of the constant flow valve, the ultrasonic oscillators being arranged facing each other at positions where side walls of the first and second rising channels intersect the axis of the straight channel; and
said flowmeter amplifier is a flowmeter amplifier to which the ultrasonic oscillators are connected through cables; and
said flowmeter sensor part and said flowmeter amplifier form an ultrasonic wave flowmeter which alternately switches between transmission and reception of the ultrasonic oscillators and measures the difference in propagation times of ultrasonic waves between the ultrasonic oscillators so as to calculate the flow rate of fluid running through the straight channel.
